(19) United States
(12) Patent Application Publication
(10) Pub. No.: US 2014/0246922 A1
(43) Pub. Date: Sep. 4, 2014

(54) ELECTRIC POWER RECEPTION DEVICE, ELECTRIC POWER TRANSMISSION DEVICE, AND ELECTRIC POWER TRANSFER SYSTEM

(71) Applicant: TOYOTA JIDOSHA KABUSHIKI KAISHA, Aichi-ken (JP)

(72) Inventors: Shinji Ichikawa, Toyota-shi (JP); Toru Nakamura, Toyota-shi (JP); Masaya Ishida, Nagakute-shi (JP); Toshiaki Watanabe, Owariasahi-shi (JP); Yasushi Amano, Nagakute-shi (JP)

(73) Assignee: TOYOTA JIDOSHA KABUSHIKI KAISHA, Toyota-shi (JP)

(21) Appl. No.: 14/352,830

(22) PCT Filed: Oct. 12, 2012
(86) PCT No.: PCT/IB2012/002053

§ 371 Date: Apr. 18, 2014

(30) Foreign Application Priority Data
Oct. 20, 2011 (JP) 2011-230800

(51) Int. Cl. H02J 5/00; H01F 38/14

(52) U.S. Cl. CPC H02J 5/005; H01F 38/14
USPC 307/104

(57) ABSTRACT

An electric power reception device includes an electric power receiver that receives electric power in a non-contact manner from an electric power transmitter that is provided externally. The electric power receiver includes a first coil that is formed by winding a first coil wire with a pitch. The first coil includes a first portion and a second portion that are adjacent to the first portion with the pitch. The first portion and the second portion are arranged in a direction of arrangement. A cross section of the first coil wire that is perpendicular to a direction of extension of the first coil wire is configured such that a length of a first projection line that is obtained by projecting the cross section from the direction of arrangement onto a first imaginary plane that is perpendicular to the direction of arrangement is larger than a length of a second projection line that is obtained by projecting the cross section from a direction that is perpendicular to the direction of arrangement onto a second imaginary plane that is perpendicular to the first imaginary plane.

### BACKGROUND OF THE INVENTION

1. Field of the Invention

The present invention relates to an electric power reception device, an electric power transmission device, and an electric power transfer system.

2. Description of Related Art

In recent years, hybrid vehicles and electric vehicles in which drive wheels are driven using electric power from a battery or the like have been drawing attention for consideration to environments.

In particular, wireless charge by which a battery can be charged in a non-contact manner without using a plug or the like have been drawing attention for use in electric vehicles that incorporate a battery. Various types of non-contact charge schemes have been proposed recently. Among others, wireless power transfer or contactless power transfer in which electric power is transferred in a non-contact manner by utilizing a resonance phenomenon is in the spotlight.

Japanese Patent Application Publication No. 2010-73976 (JP 2010-73976 A) describes an example of a wireless power transfer system that utilizes electromagnetic resonance. The wireless power transfer system includes an electric power feed device that includes an electric power feed coil, and an electric power reception device that includes an electric power reception coil. Electric power is transferred between the electric power feed coil and the electric power reception coil through electromagnetic resonance.

A wireless power feed system that is described in Japanese Patent Application Publication No. 2010-267917 (JP 2010-267917 A) includes a first self-resonance coil and a second self-resonance coil, and electric power is exchanged through electromagnetic resonance between the first self-resonance coil and the second self-resonance coil.

Various types of magnetic resonance imaging devices have been conventionally proposed, and typical examples of such devices are described in Japanese Patent Application Publication No. 2003-79597 (JP 2003-79597 A) and Japanese Patent Application Publication No. 2008-67807 (JP 2008-67807 A).

In the electric power transfer systems according to JP 2010-73976 A and JP 2010-267917 A, however, high-frequency electric power of several megahertz to several tens of megahertz is supplied to the electric power transmission device, and high-frequency electric power of several megahertz to several tens of megahertz is transmitted to the electric power reception device.

High-frequency electric power is difficult to handle, and may complicate development of peripheral devices and control during electric power transfer.

### SUMMARY OF THE INVENTION

The present invention, in view of the foregoing issue, therefore provides an electric power transmission device, an electric power reception device, and an electric power transfer system that can achieve a reduction in frequency of electric power that is supplied to the electric power transmission device and the electric power reception device.

According to an aspect of the present invention, there is provided an electric power reception device that includes an electric power reception section that receives electric power in a non-contact manner from an electric power transmission section that is provided externally. The electric power reception section includes a first coil that is formed by winding a first coil wire with a pitch. The first coil includes a first portion and a second portion that is adjacent to the first portion with the pitch. The first portion and the second portion are arranged in a direction of arrangement. A cross section of the first coil wire that is perpendicular to a direction of extension of the first coil wire is configured such that a length of a first projection line that is obtained by projecting the cross section from the direction of arrangement onto a first imaginary plane that is perpendicular to the direction of arrangement is larger than a length of a second projection line that is obtained by projecting the cross section from a direction that is perpendicular to the direction of arrangement onto a second imaginary plane that is perpendicular to the first imaginary plane.

The first coil wire may include a first main surface and a second main surface that are arranged in the direction of arrangement, and a first side surface and a second side surface that are provided to connect between the first main surface and the second main surface. Both an area of the first main surface and an area of the second main surface may be larger than both an area of the first side surface and an area of the second side surface. The pitch of the first coil may be smaller than a width of the first coil wire.

The first coil may include a first end portion and a second end portion. The first coil may be formed by bending the first coil wire so as to surround a winding center line and so as to be displaced in a direction of extension of the winding center line as the first coil wire extends from the first end portion toward the second end portion. The first portion and the second portion may be arranged in the direction of extension of the winding center line.

An interval between a center portion of the first coil that is positioned at a center portion of the first coil wire in a longitudinal direction and a portion of the first coil that is adjacent to the center portion in the direction of extension of the winding center line may be larger than an interval between the first end portion and a portion of the first coil that is adjacent to the first end portion in the direction of extension of the winding center line.

The first coil may include a first end portion and a second end portion. The first coil wire may be bent so as to surround a winding center line and so as to extend away from the winding center line as the first coil wire extends from the first end portion toward the second end portion. The first coil may be formed by winding the first coil wire such that the winding center line and the direction of arrangement of the first portion and the second portion intersect each other.

An interval between a center portion of the first coil that is positioned at a center portion of the first coil wire in a longitudinal direction and a portion of the first coil that is adjacent to the center portion in a direction that intersects the winding center line may be larger than an interval between the first end portion and a portion of the first coil that is adjacent to the first end portion in a direction that intersects the winding center line. The cross section of the first coil wire that is perpendicular to the direction of extension of the first coil wire may have a rectangular shape.

A difference between a specific frequency of the electric power transmission section and a specific frequency of the electric power reception section may be equal to or less than 10% of the specific frequency of the electric power reception section. The electric power reception section may receive electric power from the electric power transmission section through at least one of a magnetic field that is formed between the electric power reception section and the electric power transmission section and that vibrates at a particular frequency, and an electric field that is formed between the electric power reception section and the electric power transmission section and that vibrates at a particular frequency. A coupling coefficient between the electric power reception section and the electric power transmission section may be equal to or less than 0.1.

According to a further aspect of the present invention, there is provided an electric power transmission device that includes an electric power transmission section that transmits electric power in a non-contact manner to an electric power reception section that is provided externally. The electric power transmission section includes a second coil that is formed by winding a second coil wire with a pitch. The second coil includes a third portion and a fourth portion that is adjacent to the third portion with the pitch. The third portion and the fourth portion are arranged in a direction of arrangement. A cross section of the second coil wire that is perpendicular to a direction of extension of the second coil wire is configured such that a length of a third projection line that is obtained by projecting the cross section from the direction of arrangement onto a third imaginary plane that is perpendicular to the direction of arrangement is larger than a length of a fourth projection line that is obtained by projecting the cross section from a direction that is perpendicular to the direction of arrangement onto a fourth imaginary plane that is perpendicular to the third imaginary plane.

The second coil wire may include a third main surface and a fourth main surface, and a third side surface and a fourth side surface that are provided to connect between the third main surface and the fourth main surface. Both an area of the third main surface and an area of the fourth main surface may be larger than both an area of the third side surface and an area of the fourth side surface. The pitch of the second coil may be smaller than a width of the second coil wire.

The second coil may include a third end portion and a fourth end portion. The second coil may be formed by bending the second coil wire so as to surround a winding center line and so as to be displaced in a direction of extension of the winding center line as the second coil wire extends from the third end portion toward the fourth end portion. The third portion and the fourth portion may be arranged in the direction of extension of the winding center line.

An interval between a center portion of the second coil that is positioned at a center portion of the second coil wire in a longitudinal direction and a portion of the second coil that is adjacent to the center portion in the direction of extension of the winding center line may be larger than an interval between the third end portion and a portion of the second coil that is adjacent to the third end portion in the direction of extension of the winding center line.

The second coil may include a third end portion and a fourth end portion. The second coil wire may be bent so as to surround a winding center line and so as to extend away from the winding center line as the second coil wire extends from the third end portion toward the fourth end portion. The second coil may be formed by winding the second coil wire such that the winding center line and the direction of arrangement of the third portion and the fourth portion intersect each other.

An interval between a center portion of the second coil that is positioned at a center portion of the second coil wire in a longitudinal direction and a portion of the second coil that is adjacent to the center portion in a direction that intersects the winding center line may be larger, than an interval between the third end portion and a portion of the second coil that is adjacent to the third end portion in a direction that intersects the winding center line. The cross section of the second coil wire that is perpendicular to the direction of extension of the second coil wire May have a rectangular shape.

A difference between a specific frequency of the electric power transmission section and a specific frequency of the electric power reception section may be equal to or less than 10% of the specific frequency of the electric power reception section. The electric power transmission section may transmit electric power to the electric power reception section through at least one of a magnetic field that is formed between the electric power reception section and the electric power transmission section and that vibrates at a particular frequency, and an electric field that is formed between the electric power reception section and the electric power transmission section and that vibrates at a particular frequency. A coupling coefficient between the electric power reception section and the electric power transmission section may be equal to or less than 0.1.

According to another aspect of the present invention, there is provided an electric power transfer system that includes an electric power reception device that includes an electric power reception section, and an electric power transmission device that includes an electric power transmission section that transmits electric power in a non-contact manner to the electric power reception section. The electric power reception section includes a first coil that is formed by winding a first coil wire with a pitch. The first coil includes a first portion and a second portion that is adjacent to the first portion with the pitch. The first portion and the second portion are arranged in a direction of arrangement. A cross section of the first coil wire that is perpendicular to a direction of extension of the first coil wire is configured such that a length of a first projection line that is obtained by projecting the cross section from the direction of arrangement onto a first imaginary plane that is perpendicular to the direction of arrangement is larger than a length of a second projection line that is obtained by projecting the cross section from a direction that is perpendicular to the direction of arrangement onto a second imaginary plane that is perpendicular to the first imaginary plane.

According to a further aspect of the present invention, there is provided an electric power transfer system that includes an electric power reception device that includes an electric power reception section, and an electric power transmission device that includes an electric power transmission section that transmits electric power in a non-contact manner to the electric power reception section. The electric power transmission section includes a second coil that is formed by winding a second coil wire with a pitch. The second coil includes a third portion and a fourth portion that is adjacent to the third portion with the pitch. The third portion and the fourth portion are arranged in a direction of arrangement. A cross section of the second coil wire that is perpendicular to a direction of extension of the second coil wire is configured such that a length of a third projection line that is obtained by projecting the cross section from the direction of arrangement onto a third imaginary plane that is perpendicular to the direction of arrangement is larger than a length of a fourth projection line that is obtained by projecting the cross section from a direction that is perpendicular to the direction of arrangement onto a fourth imaginary plane that is perpendicular to the third imaginary plane.

With the electric power reception device, the electric power transmission device, and the electric power transfer system according to the present invention, it is possible to achieve a reduction in frequency of electric power that is supplied to the electric power reception device and the electric power transmission device.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram that schematically shows an electric power reception device, an electric power transmission device, and an electric power transfer system according to a first embodiment of the present invention;

FIG. 2 is a diagram that shows a simulation model of the electric power transfer system which is shown in FIG. 1;

FIG. 3 is a graph that shows the results of a simulation in which the relationship between the difference in specific frequency and the electric power transfer efficiency is analyzed using the simulation model which is shown in FIG. 2;

FIG. 4 is a graph that shows the relationship between the electric power transfer efficiency with the specific frequency fixed and with the air gap varied and the frequency of a current that is supplied to a coil of the electric power transmission device in the first embodiment;

FIG. 5 is a chart that shows the relationship between the distance from an electric current source (magnetic current source) and the intensity of an electromagnetic field in the first embodiment;

FIG. 6 is a perspective view that schematically shows the electric power reception device and the electric power transmission device which are shown in FIG. 1;

FIG. 7 is a perspective view that shows a part of a coil wire that forms a coil of the electric power reception device;

FIG. 8 is a cross-sectional view that shows a part of the coil of the electric power reception device;

FIG. 9 is a cross-sectional view that shows a first modification of the coil of the electric power reception device which is shown in FIG. 8;

FIG. 10 shows a second modification of the coil of the electric power reception device;

FIG. 11 is a cross-sectional view that shows a third modification of the coil 11 of the electric power reception device;

FIG. 12 is a perspective view that shows a part of the coil wire that forms a coil of the electric power transmission device;

FIG. 13 is a cross-sectional view that shows a part of the coil of the electric power transmission device;

FIG. 14 is a cross-sectional view that shows a first modification of the coil of the electric power transmission device;

FIG. 15 shows a second modification of the coil of the electric power transmission device;

FIG. 16 is a cross-sectional view that shows a third modification of the coil of the electric power transmission device;

FIG. 17 is a plan view that shows a part of the coil of the electric power reception device;

FIG. 18 is a plan view that shows a part of the coil of the electric power transmission device;

FIG. 19 is a graph that shows the resonance frequency (specific frequency) of the coil of the electric power reception device and the resonance frequency (specific frequency) of a coil according to a comparative example;

FIG. 20 is a graph that shows the electric power transfer efficiency with the air gap between the coil of the electric power reception device and the coil of the electric power transmission device varied;

FIG. 21 is a graph that shows the electric power transfer efficiency with the air gap between the coil of the electric power reception device and the coil of the electric power transmission device varied;

FIG. 22 is a perspective view that schematically shows an essential portion of an electric power reception device and an electric power transmission device according to a second embodiment of the present invention;

FIG. 23 is a cross-sectional view that shows a part of a coil of the electric power reception device according to the second embodiment;

FIG. 24 is a cross-sectional view that shows a first modification of the coil of the electric power reception device which is shown in FIG. 23;

FIG. 25 is a cross-sectional view that shows a second modification of the coil of the electric power reception device which is shown in FIG. 23;

FIG. 26 is a cross-sectional view that shows a part of a coil of the electric power transmission device according to the second embodiment;

FIG. 27 is a cross-sectional view that shows a first modification of the coil of the electric power transmission device which is shown in FIG. 26; and

FIG. 28 is a cross-sectional view that shows a second modification of the coil of the electric power transmission device which is shown in FIG. 26.

### DETAILED DESCRIPTION OF EMBODIMENTS

An electric power reception device, an electric power transmission device, and an electric power transfer system that includes the electric power transmission device and the electric power reception device according to embodiments of the present invention will be described with reference to FIGS. 1 to 28. While a plurality of embodiments are described herein, configurations that are obtained by appropriately combining the configurations described in the respective embodiments may also be included in the present invention.

First, a first embodiment of the present invention will be described with reference to the drawings. FIG. 1 is a schematic diagram that schematically shows an electric power reception device, an electric power transmission device, and an electric power transfer system according to the first embodiment.

The electric power transfer system according to the first embodiment includes an electric vehicle 10 that includes an electric power reception device 40, and an external electric power feed device 20 that includes an electric power transmission device 41. The electric vehicle 10 is parked at a predetermined position in a parking space 42 that is provided with the electric power transmission device 41. The electric power reception device 40 mainly receives electric power in a non-contact manner from the electric power transmission devices 41.

Parking curbs and lines are provided in the parking space 42 to allow the electric vehicle 10 to be parked at the predetermined position.

The external electric power feed device 20 includes a high-frequency electric power driver 22 that is connected to an AC power source 21, a control section 26 that controls drive of the high-frequency electric power driver 22 etc., and the electric power transmission device 41 which is connected to the high-frequency electric power driver 22. The electric power transmission device 41 includes a coil 23 that is connected to the high-frequency electric power driver 22, and an electric power transmission section 28. As indicated by broken lines in FIG. 1, an impedance regulator 29 may be disposed between the high-frequency electric power driver 22 and the coil 23. The electric power transmission section 28 includes a coil 24 that receives electric power from the coil 23 through electromagnetic induction. The coil 24 has a large floating capacitance. The configuration of the coil 24 will be discussed later.

Therefore, the electric power transmission section 28 has an electric circuit that is formed by the inductance L of the coil 24 and the capacitance C of the coil 24. As indicated by broken lines in FIG. 1, a capacitor 25 may be provided between both ends of the coil 24. In this case, the electric power transmission section 28 has an electric circuit that is formed by the capacitances of the coil 24 and the capacitor 25 and the inductance of the coil 24.

The electric vehicle 10 includes the electric power reception device 40, a rectifier 13 that is connected to the electric power reception device 40, a DC/DC converter 14 that is connected to the rectifier 13, a battery 15 that is connected to the DC/DC converter 14, a power control unit (PCU) 16, a motor unit 17 that is connected to the power control unit 16, and a vehicle electronic control unit (ECU) 18 that controls drive of the DC/DC converter 14, the power control unit 16, etc. The electric vehicle 10 according to the embodiment is a hybrid vehicle that includes an engine (not shown), but may be any vehicle that is driven by a motor such as an electric vehicle or a fuel-cell vehicle.

The rectifier 13 is connected to a coil 12, and converts an AC current that is supplied from the coil 12 into a DC current to supply the resulting DC current to the DC/DC converter 14.

The DC/DC converter 14 regulates the voltage of the DC current which is supplied from the rectifier 13 to supply the resulting DC current to the battery 15. The DC/DC converter 14 is not an essential component, and may be dispensed with. In this case, the DC/DC converter 14 may be replaced with a matching unit that is provided in the external electric power feed device 20 between the electric power transmission device 41 and the high-frequency electric power driver 22 to perform impedance matching.

The power control unit 16 includes a converter that is connected to the battery 15, and an inverter that is connected to the converter. The converter regulates (raises the voltage of) the DC current which is supplied from the battery 15 to supply the resulting DC current to the inverter. The inverter converts the DC current which is supplied from the converter into an AC current to supply the resulting AC current to the motor unit 17.

The motor unit 17 may be a three-phase AC motor, for example, and is driven by the AC current which is supplied from the inverter of the power control unit 16.

In the case where the electric vehicle 10 is a hybrid vehicle, the electric vehicle 10 further includes an engine and a power split mechanism, and the motor unit 17 includes a motor generator that mainly functions as an electric generator and a motor generator that mainly functions as an electric motor.

The electric power reception device 40 includes an electric power reception section 27 and the coil 12. The electric power reception section 27 includes a coil 11. The coil 11 also has a large floating capacitance. Therefore, the electric power reception section 27 has an electric circuit that is formed by the inductance of the coil 11 and the capacitance of the coil 11. As indicated by broken lines in FIG. 1, a capacitor 19 may be provided to connect between both ends of the coil 11. In this case, the electric power reception section 27 has an electric circuit that is formed by the inductance of the coil 11 and the floating capacitance of the coil 11 and the capacitance of the capacitor 19.

In the electric power transfer system according to the embodiment, the difference between the specific frequency of the electric power transmission section 28 and the specific frequency of the electric power reception section 27 is equal to or less than 10% of the specific frequency of the electric power reception section 27 or the electric power transmission section 28. The electric power transfer efficiency can be enhanced by setting the specific frequencies of the electric power transmission section 28 and the electric power reception section 27 in such a range. If the difference in specific frequency is more than 10% of the specific frequency of the electric power reception section 27 or the electric power transmission section 28, on the other hand, the electric power transfer efficiency is less than 10%, which may disadvantageously increase the charge time of the battery 15.

In the case where the capacitor 25 is not provided, the specific frequency of the electric power transmission section 28 means the vibration frequency of free vibration of an electric circuit which is formed by the inductance of the coil 24 and the capacitance of the coil 24. In the case where the capacitor 25 is provided, the specific frequency of the electric power transmission section 28 means the vibration frequency of free vibration of an electric circuit which is formed by the capacitances of the coil 24 and the capacitor 25 and the inductance of the coil 24. The specific frequency obtained when the braking force and the electrical resistance are zero or substantially zero in the electric circuit described above is also referred to as the resonance frequency of the electric power transmission section 28.

Similarly, in the case where the capacitor 19 is not provided, the specific frequency of the electric power reception section 27 means the vibration frequency of free vibration of an electric circuit which is formed by the inductance of the coil 11 and the capacitance of the coil 11. In the case where the capacitor 19 is provided, the specific frequency of the electric power reception section 27 means the vibration frequency of free vibration of an electric circuit which is formed by the capacitances of the coil 11 and the capacitor 19 and the inductance of the coil 11. The specific frequency obtained when the braking force and the electrical resistance are zero or substantially zero, in the electric circuit described above, is also referred to as the resonance frequency of the electric power reception section 27.

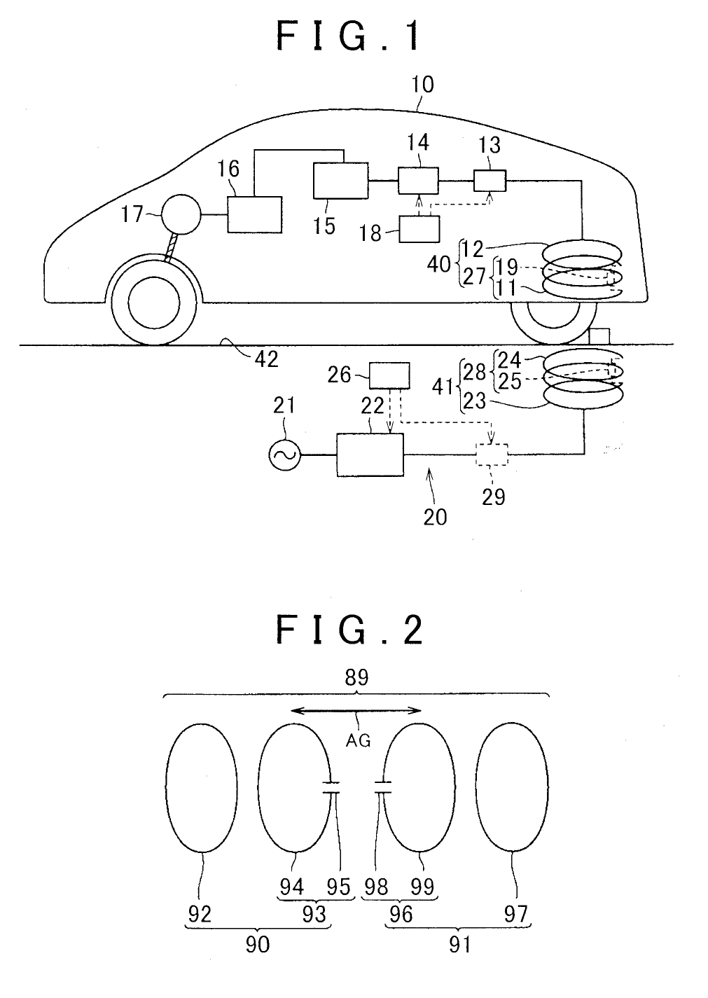

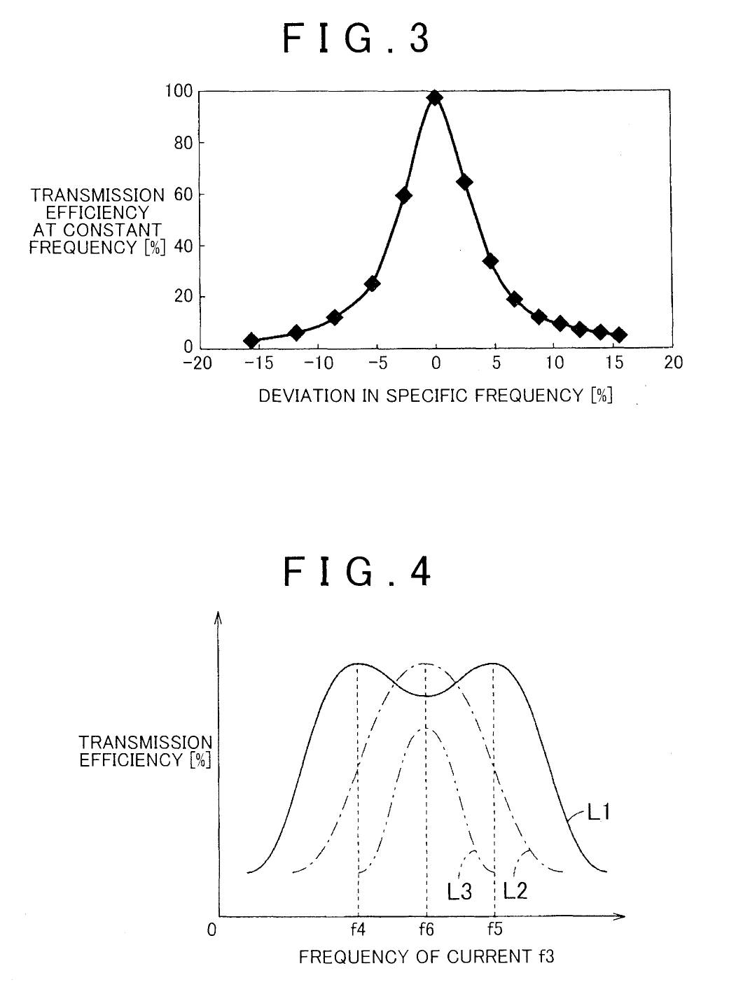

The results of a simulation in which the relationship between the difference in specific frequency and the electric power transfer efficiency is analyzed will be described with reference to FIGS. 2 and 3. FIG. 2 shows a simulation model of the electric power transfer system. An electric power transfer system 89 includes an electric power transmission device 90 and an electric power reception device 91. The electric power transmission device 90 includes a coil 92 and an electric power transmission section 93. The electric power transmission section 93 includes a coil 94 and a capacitor 95 that is provided in the coil 94.

The electric power reception device 91 includes an electric power reception section 96 and a coil 97. The electric power reception section 96 includes a coil 99 and a capacitor 98 that is connected to the coil 99.

The inductance of the coil 94 is defined as Lt. The capacitance of the capacitor 95 is defined as C1. The inductance of the coil 99 is defined as Lr. The capacitance of the capacitor 98 is defined as C2. When the parameters are set in this way, the specific frequency f1 of the electric power transmission section 93 is indicated by the following formula (1), and the specific frequency f2 of the electric power reception section 96 is indicated by the following formula (2):

f1=1/{2π(Lt×C1)^{1/2}} (1)

f2=1/{2π(Lr×C2)^{1/2}} (2)

The relationship between the deviation between the specific frequencies of the electric power transmission section 93 and the electric power reception section 96 and the electric power transfer efficiency with the inductance Lr and the capacitances C1 and C2 fixed and with only the inductance Lt varied is shown in FIG. 3. In the simulation, the relative positional relationship between the coil 94 and the coil 99 is fixed, and the frequency of a current that is supplied to the electric power transmission section 93 is constant.

In the graph which is shown in FIG. 3, the horizontal axis indicates the deviation (%) in specific frequency, and the vertical axis indicates the transfer efficiency (%) at a constant frequency. The deviation [%] in specific frequency is indicated by the following formula (3).

(Deviation in specific frequency)={(f1−f2)/f2}×100(%) (3)

As is clear from FIG. 3, in the case where the deviation (%) in specific frequency is ±0%, the electric power transfer efficiency is close to 100%. In the case where the deviation (%) in specific frequency is ±5%, the electric power transfer efficiency is 40%. In the case where the deviation (%) in specific frequency is ±10%, the electric power transfer efficiency is 10%. In the case where the deviation (%) in specific frequency is ±15%, the electric power transfer efficiency is 5%. That is, it is seen that the electric power transfer efficiency can be enhanced by setting the specific frequencies of the electric power transmission section and the electric power reception section such that the absolute value of the deviation (%) in specific frequency (difference in specific frequency) is in the range of equal to or less than 10% of the specific frequency of the electric power reception section 96. Further, it is seen that the electric power transfer efficiency can be further enhanced by setting the specific frequencies of the electric power transmission section and the electric power reception section such that the absolute value of the deviation (%) in specific frequency is equal to or less than 5% of the specific frequency of the electric power reception section 96. Electromagnetic field analysis software (JMAG (registered trademark), manufactured by JSOL Corporation) is used as simulation software.

Next, operation of the electric power transfer system according to the embodiment will be described. In FIG. 1, AC power is supplied from the high-frequency electric power driver 22 to the coil 23. When a predetermined AC current flows through the coil 23, an AC current also flows through the coil 24 through electromagnetic induction. In this event, electric power is supplied to the coil 23 such that the AC current which flows through the coil 24 has a particular frequency.

When a current at a particular frequency flows through the coil 24, an electromagnetic field that vibrates at the particular frequency is formed around the coil 24.

The coil 11 is disposed within a predetermined range from the coil 24, and receives electric power from the electromagnetic field which is formed around the coil 24.

In the embodiment, the coil 11 and the coil 24 are each a so-called helical coil. Therefore, a magnetic field that vibrates at the particular frequency is mainly formed around the coil 24, and the coil 11 receives electric power from the magnetic field.

The magnetic field at the particular frequency which is formed around the coil 24 will be described. The “magnetic field at the particular frequency” is typically correlated with the electric power transfer efficiency and the frequency of a current that is supplied to the coil 24. Thus, the relationship between the electric power transfer efficiency and the frequency of the current which is supplied to the coil 24 will be described first. The electric power transfer efficiency for transfer of electric power from the coil 24 to the coil 11 is varied by various factors such as the distance between the coil 24 and the coil 11. For example, the specific frequency (resonance frequency) of the electric power transmission section 28 and the electric power reception section 27 is defined as f0, the frequency of the current which is supplied to the coil 24 is defined as f3, and the air gap between the coil 11 and the coil 24 is defined as AG.

FIG. 4 is a graph that shows the relationship between the electric power transfer efficiency with the specific frequency f0 fixed and with the air gap AG varied and the frequency f3 of the current which is supplied to the coil 24.

In the graph which is shown in FIG. 4, the horizontal axis indicates the frequency f3 of the current which is supplied to the coil 24, and the vertical axis indicates the electric power transfer efficiency (%). An efficiency curve L1 schematically indicates the relationship between the electric power transfer efficiency obtained when the air gap AG is small and the frequency f3 of the current which is supplied to the coil 24. As indicated by the efficiency curve L1, in the case where the air gap AG is small, the electric power transfer efficiency reaches its peaks at frequencies f4 and f5 (f4<f5). As the air gap AG becomes larger, the two peaks of the electric power transfer efficiency move closer to each other. Then, when the air gap AG is larger than a predetermined distance, the electric power transfer efficiency has one peak, which is reached when the frequency of the current which is supplied to the coil 24 is f6, as indicated by an efficiency curve L2. As the air gap AG becomes larger than that for the efficiency curve L2, the peak of the electric power transfer efficiency becomes smaller as indicated by an efficiency curve L3.

In order to improve the electric power transfer efficiency, the following first scheme is conceivable, for example. As the first scheme, it is conceivable to vary the electric power transfer efficiency characteristics between the electric power transmission section 28 and the electric power reception section 27 by varying the capacitances of the capacitor 25 and the capacitor 19 in accordance with the air gap AG with the frequency of the current which is supplied to the coil 24 which is illustrated in FIG. 1 kept constant. Specifically, the capacitances of the capacitor 25 and the capacitor 19 are adjusted such that the electric power transfer efficiency reaches its peak with the frequency of the current which is supplied to the coil 24 kept constant. In the scheme, the frequency of the current which flows through the coil 24 and the coil 11 is constant regardless of the size of the air gap AG. Other schemes to vary the electric power transfer efficiency characteristics include a scheme in which a matching unit that is provided between the electric power transmission device 41 and the high-frequency electric power driver 22 is utilized, and a scheme in which the converter 14 is utilized.

As a second scheme, the frequency of the current which is supplied to the coil 24 is adjusted on the basis of the size of the air gap AG. For example, in the case where the electric power transfer efficiency characteristics are as indicated by the efficiency curve L1 in FIG. 4, a current at the frequency f4 or the frequency f5 is supplied to the coil 24. In the case where the electric power transfer efficiency characteristics are as indicated by the efficiency curve L2 or L3, meanwhile, a current at the frequency f6 is supplied to the coil 24. In the case, the frequency of the current which flows through the coil 24 and the coil 11 is varied in accordance with the size of the air gap AG.

In the first scheme, the frequency of the current which flows through the coil 24 is constant. In the second scheme, the frequency of the current which flows through the coil 24 is varied appropriately in accordance with the air gap AG. A current at a particular frequency that is set so as to enhance the electric power transfer efficiency using the first scheme or the second scheme is supplied to the coil 24. When a current at a particular frequency flows through the coil 24, a magnetic field (electromagnetic field) that vibrates at the particular frequency is formed around the coil 24. The electric power reception section 27 receives electric power from the electric power transmission section 28 through a magnetic field that is formed between the electric power reception section 27 and the electric power transmission section 28 and that vibrates at the particular frequency. Thus, the “magnetic field that vibrates at a particular frequency” is not necessarily limited to a magnetic field that vibrates at a fixed frequency. In the example described above, the frequency of the current which is supplied to the coil 24 is set with focus on the air gap AG. However, the electric power transfer efficiency may be varied by other factors such as displacement between the coil 24 and the coil 11 in the horizontal direction, and the frequency of the current which is supplied to the coil 24 may be adjusted on the basis of such other factors.

In the embodiment, helical coils are used as the coils. However, antennas such as meander lines may also be used as the coils. In this case, a current at a particular frequency flows through the coil 24 so that an electric field that vibrates at the particular frequency is formed around the coil 24. Then, electric power is transferred between the electric power transmission section 28 and the electric power reception section 27 through the electric field.

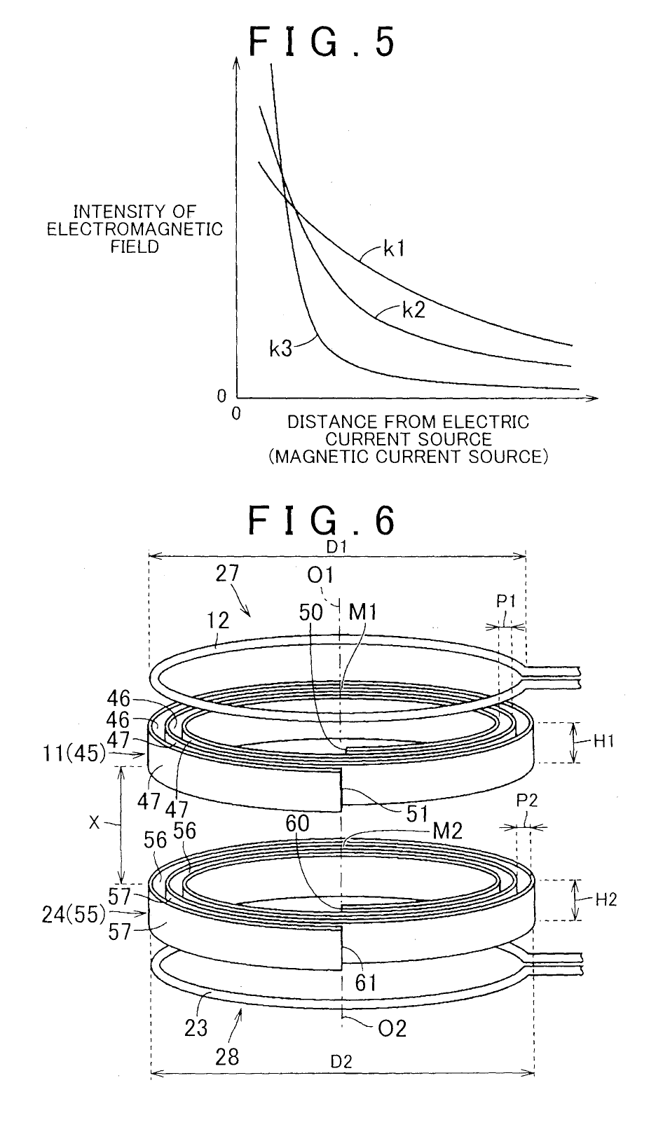

In the electric power transfer system according to the embodiment, the electric power transmission and electric power reception efficiencies are improved by utilizing a near field (evanescent field) in which an “electrostatic field” of an electromagnetic field is dominant. FIG. 5 is a chart that shows the relationship between the distance from an electric current source (magnetic current source) and the intensity of an electromagnetic field. With reference to FIG. 5, the electromagnetic field includes three components. A curve k1 corresponds to a component that is inversely proportional to the distance from the wave source, which is referred to as a “radiation electric field”. A curve k2 corresponds to a component that is inversely proportional to the square of the distance from the wave source, which is referred to as an “induction electric field”. A curve k3 corresponds to a component that is inversely proportional to the cube of the distance from the wave source, which is referred to as an “electrostatic field”. If the wavelength of the electromagnetic field is defined as “λ.”, the intensities of the “radiation electric field”, the “induction electric field”, and the “electrostatic field” are generally equal at a distance represented by λ/2π.

The “electrostatic field” is a region in which the intensity of the electromagnetic wave is drastically reduced in accordance with the distance from the wave source. In the electric power transfer system according to the embodiment, energy (electric power) is transferred utilizing the near field (evanescent field) in which the “electrostatic field” is dominant. That is, energy (electric power) is transferred from the electric power transmission section 28 to the electric power reception section 27 by resonating the electric power transmission section 28 and the electric power reception section 27 (for example, a pair of LC resonant coils) having close specific frequencies in the near field in which the “electrostatic field” is dominant. The “electrostatic field” does not propagate energy to far locations. Thus, electricity can be transmitted with less energy loss through resonance compared to electromagnetic waves that transfer energy (electric power) through the “radiation electric field” which propagates energy to far locations.

In the electric power transfer system according to the embodiment, electric power is thus transmitted from the electric power transmission device 41 to the electric power reception device 40 by resonating the electric power transmission section 28 and the electric power reception section 27 through the electromagnetic field. The coupling coefficient (κ) between the electric power transmission section 28 and the electric power reception section 27 is equal to or less than 0.1. In common electric power transfer in which electromagnetic induction is utilized, the coupling coefficient (κ) between an electric power transmission section and an electric power reception section is close to 1.0.

Coupling between the electric power transmission section 28 and the electric power reception section 27 in the electric power transfer according to the embodiment may be referred to as “magnetic resonant coupling”, “magnetic-field resonant coupling”, “electromagnetic-field resonant coupling”, or “electric-field resonant coupling”.

The term “electromagnetic-field resonant coupling” means coupling that includes any of “magnetic resonant coupling”, “magnetic-field resonant coupling”, and “electric-field resonant coupling”.

Coil-shaped antennas are used as the coil 24 of the electric power transmission section 28 and the coil 11 of the electric power reception section 27 described herein. Therefore, the electric power transmission section 28 and the electric power reception section 27 are mainly coupled to each other through the magnetic field, and the electric power transmission section 28 and the electric power reception section 27 are subjected to “magnetic resonant coupling” or “magnetic-field resonant coupling”.

Antennas such as meander lines, for example, may also be used as the coils 24 and 11. In this case, the electric power transmission section 28 and the electric power reception section 27 are mainly coupled to each other through the electric field. At this time, the electric power transmission section 28 and the electric power reception section 27 are subjected to “electric-field resonant coupling”.

FIG. 6 is a perspective view that schematically shows the electric power reception device 40 and the electric power transmission device 41. In the example which is shown in FIG. 6, the coil 11 is not provided with the capacitor 19, and the coil 24 is not provided with the capacitor 25. As shown in FIG. 6, the electric power transmission section 28 includes the coil 23 which includes generally one turn, and the coil 24 which is disposed above the coil 23. The electric power reception section 27 includes the coil 11, and the coil 12 which is disposed above the coil 11 and which includes generally one turn.

Both the coil 11 and the coil 24 are formed from a coil wire. The coil 11, 24 is formed by winding a coil wire with a pitch P1, P2, respectively. The pitch P1, P2 is set to a range of equal to or more than 2 mm and equal to or less than 5 mm, for example.

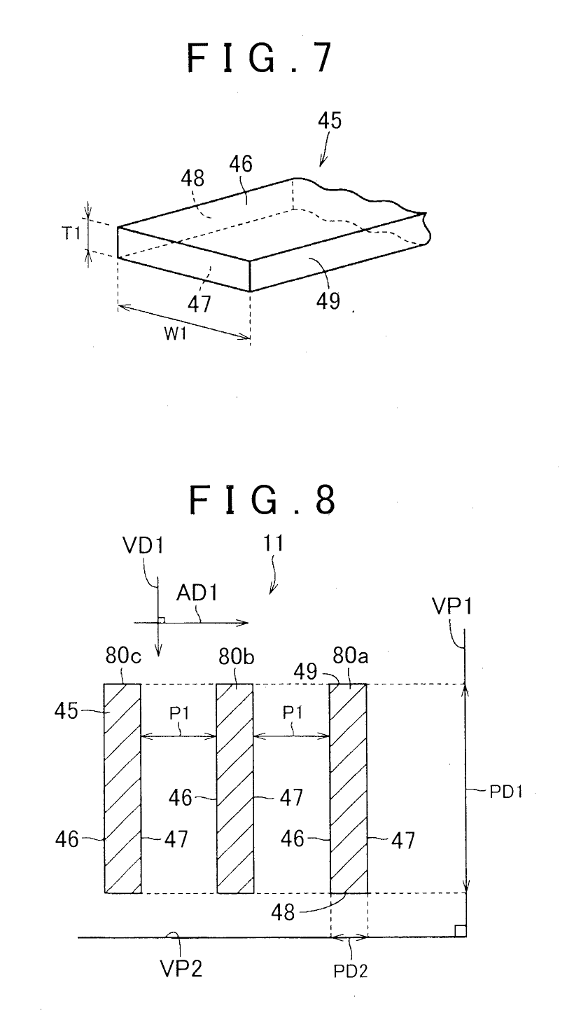

FIG. 7 is a perspective view that shows a part of a coil wire 45 that forms the coil 11. As shown in FIG. 7, the coil wire 45 includes a main surface 46 and a main surface 47 that are arranged in the thickness direction of the coil wire 45, and a side surface 48 and a side surface 49 that are arranged in the width direction of the coil wire 45. The width W1 of the coil wire 45 is approximately set to be equal to or more than 1 cm (10 mm) and equal to or less than 2 cm (20 mm), for example. The thickness T1 of the coil wire 45 is approximately set to be equal to or more than 1 mm and equal to or less than 2 mm, for example.

Both the area of the main surface 46 and the area of the main surface 47 are equal to or larger than the area of the side surface 48 and the area of the side surface 49.

In the example which is shown in FIG. 7, the coil wire 45 is formed such that the cross section of the coil wire 45 that is perpendicular to the direction of extension of the coil wire 45 has a rectangular shape. The cross-sectional shape of the coil wire 45 is not limited thereto, and may be an oval shape or an elliptical shape, for example. In this case, the area of the main surface is defined as an area that is obtained by projecting the coil wire from a direction that is perpendicular to the major axis onto an imaginary plane that is parallel to the direction of extension of the major axis and to the direction of extension of the coil wire. In addition, the area of the side surface is defined as an area that is obtained by projecting the coil wire from a direction that is perpendicular to the minor axis onto an imaginary plane that is parallel to the direction of extension of the minor axis and to the direction of extension of the coil wire.

In FIG. 6, the coil 11 is formed by winding the coil wire 45 such that the main surface 46 and the main surface 47 which are shown in FIG. 7 face each other with a pitch P1.

In the example which is shown in FIG. 6, the coil 11 includes an end portion 50 and an end portion 51. The coil wire 45 is bent so as to surround a winding center line O1 and so as to extend away from the winding center line O1 as the coil wire 45 extends from the end portion 50 toward the end portion 51. Typically, the coil wire 45 is formed in a swirling shape that is concentric about the winding center line O1. However, the coil wire 45 may be formed in various shapes.

FIG. 8 is a cross-sectional view that shows a part of the coil 11. The cross-sectional view which is shown in FIG. 8 shows a cross section that is perpendicular to the direction of extension of the coil wire 45. The coil 11 includes a first portion 80a, a second portion 80b that is adjacent to the first portion 80a with a pitch P1, and a third portion 80c that is adjacent to the second portion 80b with a pitch P1. The direction of the pitch P1 is perpendicular to the winding center line O1.

In the example which is shown in FIG. 8, the center of the cross section of the third portion 80c, the center of the cross section of the second portion 80b, and the center of the cross section of the first portion 80a are arranged in a direction of arrangement AD1. The direction of arrangement AD1 is perpendicular to the winding center line O1 which is shown in FIG. 6. The direction of the pitch P1 and the direction of arrangement AD1 are parallel to each other.

A direction that is perpendicular to the direction of arrangement AD1 is defined as a vertical direction VD1. An imaginary plane that is perpendicular to the direction of arrangement AD1 is defined as an imaginary plane VP1. An imaginary plane that is perpendicular to the vertical direction VD1 is defined as an imaginary plane VP2.

A projection line segment that is obtained by projecting the cross section of the first portion 80a from the direction of arrangement AD1 onto the imaginary plane VP1 is defined as a projection line segment PD1. An imaginary line segment that is obtained by projecting the cross section of the first portion 80a from the vertical direction VD1 onto the imaginary plane VP2 is defined as a projection line segment PD2. As is clear from FIG. 8, the length of the projection line segment PD1 is larger than the length of the projection line segment PD2.

The floating capacitance of the coil 11 is formed at portions of the first portion 80a and the second portion 80b that face each other in the direction of arrangement AD1, and at portions of the second portion 80b and the third portion 80c that face each other in the direction of arrangement AD1. In the example which is shown in FIG. 8, the main surface 46 of the first portion 80a and the main surface 47 of the second portion 80b face each other in the direction of arrangement AD1. In addition, the main surface 46 of the second portion 80b and the main surface 47 of the third portion 80c face each other in the direction of arrangement AD1. A floating capacitance is formed between the facing portions.

On the other hand, the side surface 49 and the side surface 48 which are arranged in the vertical direction VD1, among the peripheral portions of the first portion 80a, the second portion 80b, and the third portion 80c, do not contribute to the formation of the floating capacitance.

In the example which is shown in FIG. 8, the cross section of the coil wire 45 which is perpendicular to the direction of extension of the coil wire 45 is formed such that the projection line segment PD1 is larger than the projection line segment PD2. Therefore, the coil 11 has a large floating capacitance. With the formation of such a large floating capacitance, the specific frequency of the electric field formed by the coil 11 can be lowered.

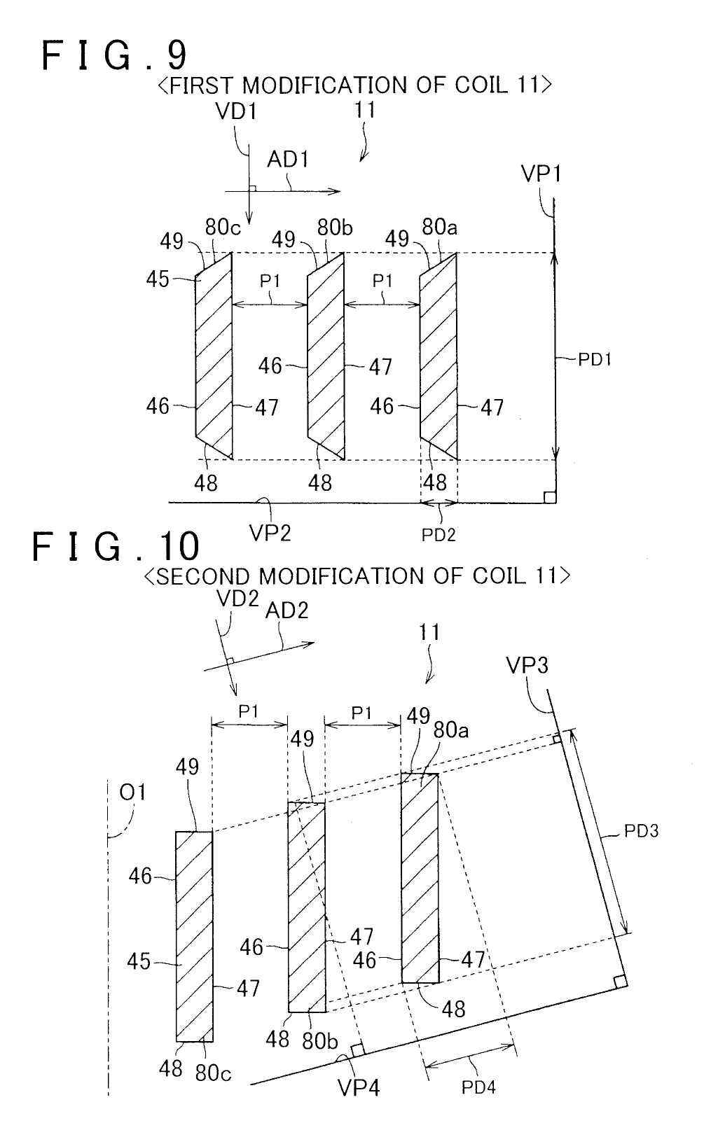

The shape of the coil wire 45 is not limited to a rectangular shape. FIG. 9 is a cross-sectional view that shows a first modification of the coil 11 which is shown in FIG. 8. In the example which is shown in FIG. 9, the coil wire 45 is formed such that the cross section of the coil wire 45 that is perpendicular to the direction of extension of the coil wire 45 has a trapezoidal shape.

Also in the example which is shown in FIG. 9, the projection line segment PD1 which is obtained by projecting the cross section of the coil 11 onto the imaginary plane VP1 is larger than the projection line segment PD2 which is obtained by projecting the cross section of the coil 11 onto the imaginary plane VP2. Also in the example which is shown in FIG. 9, the third portion 80c, the second portion 80b, and the first portion 80a are arranged with a pitch P1 between each other in the direction of arrangement AD1.

For the third portion 80c and the second portion 80b, the main surface 47 of the third portion 80c and the main surface 46, the side surface 48, and the side surface 49 of the second portion 80b face each other. A capacitance is formed between the facing portions.

Also in the example which is shown in FIG. 9, the projection line segment PD1 is longer than the projection line segment PD2. Therefore, also in the example which is shown in FIG. 9, a large capacitance can be secured.

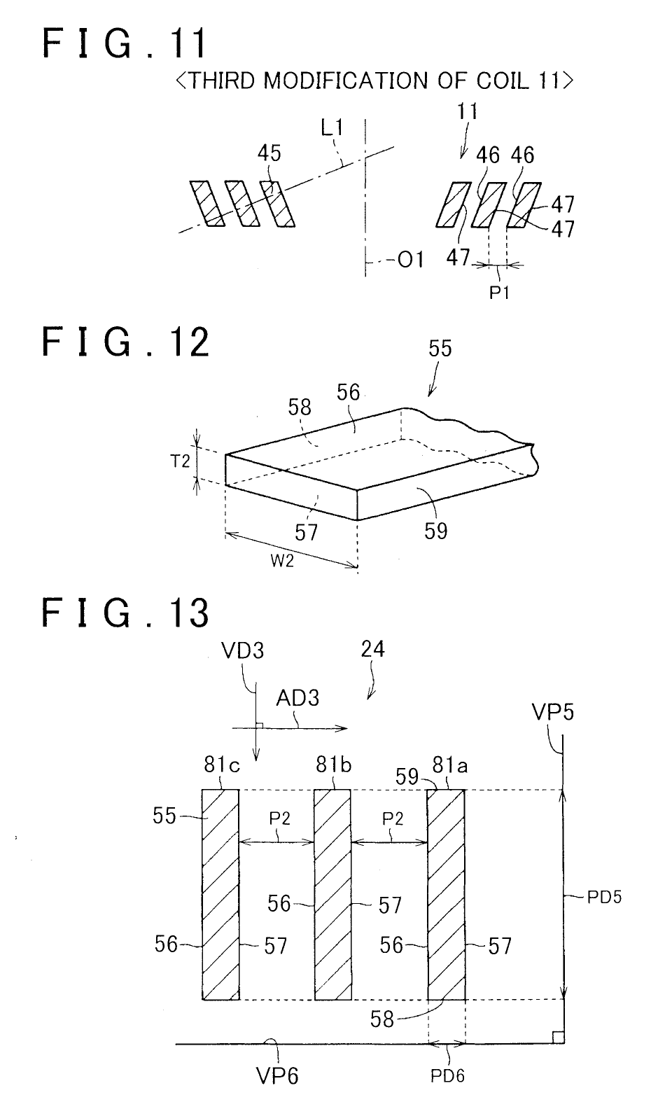

FIG. 10 shows a second modification of the coil 11. In the example which is shown in FIG. 10, the coil 11 is formed by winding the coil wire 45 such that the coil wire 45 is displaced in the direction of extension of the winding center line O1 and a direction that is perpendicular to the winding center line O1 as the coil wire 45 extends from an inner peripheral end portion toward an outer peripheral end portion.

In the example which is shown in FIG. 10, the center of the cross section of the third portion 80c, the center of the cross section of the second portion 80b, and the center of the cross section of the first portion 80a are arranged in a direction of arrangement AD2. An imaginary plane that is perpendicular to the direction of arrangement AD2 is defined as an imaginary plane VP3. An imaginary plane that is perpendicular to the imaginary plane VP3 is defined as an imaginary plane VP4. The direction of the pitch P1 is orthogonal to the winding center line O1. The direction of arrangement AD2 is not orthogonal to the winding center line O1. Therefore, the direction of arrangement AD2 and the direction of the pitch P1 intersect each other. A direction that is perpendicular to the direction of arrangement AD2 is defined as a vertical direction VD2.

The cross section of the first portion 80a which is perpendicular to the coil wire 45 will be considered. A line segment that is obtained by projecting the cross section of the first portion 80a from the direction of arrangement AD2 onto the imaginary plane VP3 is defined as a projection line segment PD3. Further, a line segment that is obtained by projecting the cross section of the first portion 80a from the vertical direction VD2 onto the imaginary plane VP4 is defined as a projection line segment PD4. Also in the example which is shown in FIG. 10, the coil wire 45 is formed such that the projection line segment PD3 is longer than the projection line segment PD4.

Therefore, the first portion 80a and the second portion 80b face each other in the direction of arrangement AD2 over a large area, and the third portion 80c and the second portion 80b face each other in the direction of arrangement AD2 over a large area, for example, which increases the capacitance of the coil 11.

In the example which is shown in FIG. 10 etc., the main surface 46 and the main surface 47 which is positioned on the winding center line O1 side with respect to the main surface 46 with a pitch P1 are arranged in a direction that is perpendicular to the winding center line O1. However, the main surface 46 and the main surface 47 may be formed at a certain angle with respect to the winding center line O1 as necessary.

In the example which is shown in FIG. 6, the coil 11 is formed such that the main surface 46 and the main surface 47 which face each other with a pitch P1 are arranged in a direction that is perpendicular to the winding center line O1. However, the shape of the coil 11 is not limited thereto.

FIG. 11 is a cross-sectional view that shows a third modification of the coil 11. In the example which is shown in FIG. 11, the main surface 46 and the main surface 47 of the coil 11 are arranged on an imaginary line L1 that intersects the winding center line O1 at an angle that is less than 90 degrees.

In the example which is shown in FIG. 11, the coil 11 is formed such that the main surface 46 and the main surface 47 of the coil wire 45 are arranged on an imaginary line (imaginary plane) that extends in a direction that intersects the winding center line O1. A floating capacitance is formed between the main surface 46 and the main surface 47 which face each other with a pitch P1.

The areas of the main surface 46 and the main surface 47 are large, and therefore the floating capacitance which is formed between the main surface 46 and the main surface 47 is also large. The pitch P1 of the coil 11 is smaller than the height H1 of the coil 11 (width W1 of the coil wire 45), and therefore a larger capacitance is formed, between the main surface 46 and the main surface 47. Thus, an increase in floating capacitance of the coil 11 reduces the specific frequency of the electric circuit which is formed by the floating capacitance of the coil 11 and the inductance of the coil 11.

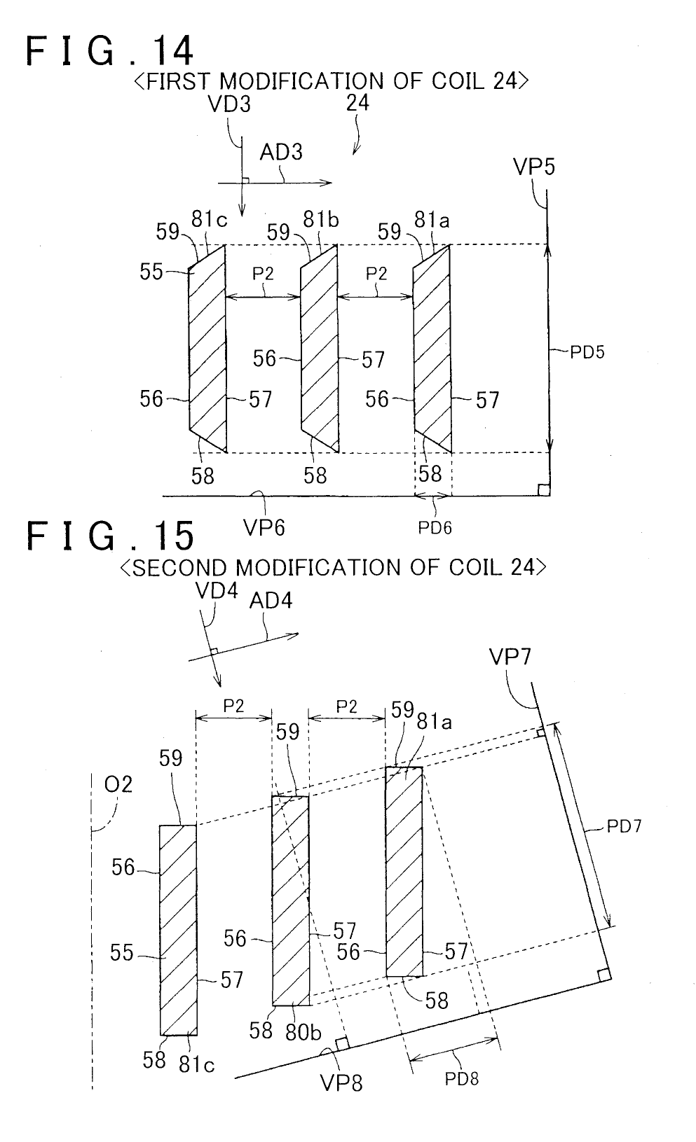

In FIG. 6, the coil 24 is also formed by winding a coil wire 55 with a pitch. FIG. 12 is a perspective view that shows a part of the coil wire 55 which forms the coil 24. As shown in FIG. 12, the coil wire 55 includes a main surface 56 and a main surface 57 that are arranged in the thickness direction of the coil wire 55, and a side surface 58 and a side surface 59 that are arranged in the width direction of the coil wire 55.

Both the area of the main surface 56 and the area of the main surface 57 are equal to or larger than the area of the side surface 58 and the area of the side surface 59.

In the example which is shown in FIG. 12, the coil wire 55 is formed such that the cross section of the coil wire 55 that is perpendicular to the direction of extension of the coil wire 55 has a generally rectangular shape. The cross-sectional shape of the coil wire 55 is not limited to a rectangular shape, and may be an oval shape or an elliptical shape, for example.

In FIG. 6, the coil 24 is formed by winding the coil wire 55 such that the main surface 56 and the main surface 57 which are shown in FIG. 12 face each other with a pitch P2.

In the example which is shown in FIG. 6, the coil 24 includes an end portion 60 and an end portion 61. The coil wire 55 is bent so as to surround a winding center line O2 and so as to extend away from the winding center line O2 as the coil wire 55 extends from the end portion 60 toward the end portion 61.

In the example which is shown in FIG. 6, the main surface 56 and the main surface 57 which faces the main surface 56 with a pitch P2 are arranged in a direction that is perpendicular to the winding center line O2.

FIG. 13 is a cross-sectional view that shows a part of the coil 24. The cross-sectional view which is shown in FIG. 13 shows a cross section that is perpendicular to the direction of extension of the coil wire 55. In FIG. 13, the coil 24 includes a first portion 81a that is a part of the coil 24, a second portion 81b that is adjacent to the first portion 81a with a pitch P2, and a third portion 81c that is adjacent to the second portion 81b with a pitch P2. The direction of the pitch P2 is perpendicular to the winding center line O2.

The center of the cross section of the third portion 81c, the center of the cross section of the second portion 81b, and the center of the cross section of the first portion 81a are arranged in a direction of arrangement AD3. The direction of arrangement AD3 is perpendicular to the winding center line O2 which is shown in FIG. 6.

A direction that is perpendicular to the direction of arrangement AD3 is defined as a vertical direction VD3. An imaginary plane that is perpendicular to the direction of arrangement AD3 is defined as an imaginary plane VP5. An imaginary plane that is perpendicular to the direction of arrangement AD3 is defined as an imaginary plane VP6. A projection line segment that is obtained by projecting the cross section of the first portion 81a from the direction of arrangement AD3 onto the imaginary plane VP5 is defined as a projection line segment PD5. An imaginary line segment that is obtained by projecting the cross section of the first portion 81a from the vertical direction VD3 onto the imaginary plane VP6 is defined as a projection line segment PD6. As is clear from FIG. 13, the length of the projection line segment PD5 is larger than the length of the projection line segment PD6.

The floating capacitance of the coil 24 is formed at portions of the first portion 81a and the second portion 81b that face each other in the direction of arrangement AD3, and at portions of the second portion 81b and the third portion 81c that face each other in the direction of arrangement AD3. In the example which is shown in FIG. 13, the main surface 56 of the first portion 81a and the main surface 57 of the second portion 81b face each other in the direction of arrangement AD3. In addition, the main surface 56 of the second portion 81b and the main surface 57 of the third portion 81c face each other in the direction of arrangement AD3. A floating capacitance is formed between the facing portions. On the other hand, the side surface 59 and the side surface 58 which are arranged in the vertical direction VD3, among the peripheral portions of the first portion 81a, the second portion 81b, and the third portion 81c, do not contribute to the formation of the floating capacitance.

In the example which is shown in FIG. 13, the cross section of the coil wire 55 which is perpendicular to the direction of extension of the coil wire 55 is formed such that the projection line segment PD5 is larger than the projection line segment PD6. Therefore, a large floating capacitance is formed in the coil 24. With the formation of such a large floating capacitance, the specific frequency of the electric field formed by the coil 24 can be lowered.

The shape of the coil wire 55 is not limited to a rectangular shape. FIG. 14 is a cross-sectional view that shows a first modification of the coil 24 which is shown in FIG. 13. In the example which is shown in FIG. 14, the coil wire 55 is formed such that the cross section of the coil wire 55 that is perpendicular to the direction of extension of the coil wire 55 has a trapezoidal shape.

Also in the example which is shown in FIG. 14, the projection line segment PD5 which is obtained by projecting the cross section of the coil 24 onto the imaginary plane VP5 is larger than the projection line segment. PD6 which is obtained by projecting the cross section of the coil 24 onto the imaginary plane VP6. Also in the example which is shown in FIG. 14, the third portion 81c, the second portion 81b, and the first portion 81a are arranged with a pitch P2 between each other in the direction of arrangement AD3.

For the third portion 81c and the second portion 81b, the main surface 57 of the third portion 81c and the main surface 56, the side surface 58, and the side surface 59 of the second portion 81b face each other. A capacitance is formed between the facing portions. Similarly, a capacitance is formed between the second portion 81b and the first portion 81a.

Also in the example which is shown in FIG. 14, the projection line segment PD5 is longer than the projection line segment PD6. Therefore, also in the example which is shown in FIG. 14, a large capacitance can be secured.

FIG. 15 shows a second modification of the coil 24. In the example which is shown in FIG. 15, the coil 24 is formed by winding the coil wire 55 such that the coil wire 55 is displaced in the direction of extension of the winding center line O2 and a direction that is perpendicular to the winding center line O2 as the coil wire 55 extends from an inner peripheral end portion toward an outer peripheral end portion.

In the example which is shown in FIG. 15, the center of the cross section of the third portion 81c, the center of the cross section of the second portion 81b, and the center of the cross section of the first portion 81a are arranged in a direction of arrangement AD4. In the example which is shown in FIG. 15, the direction of arrangement AD4 is not orthogonal to the winding center line O2. The direction of the pitch P2 is orthogonal to the winding center line O2. Therefore, the direction of the pitch P2 and the direction of arrangement AD4 intersect each other. An imaginary plane that is perpendicular to the direction of arrangement AD4 is defined as an imaginary plane VP7. An imaginary plane that is perpendicular to the imaginary plane VP7 is defined as an imaginary plane VP8.

The cross section of the first portion 81a which is perpendicular to the coil wire 55 will be considered. A line segment that is obtained by projecting the cross section of the first portion 81a from the direction of arrangement AD4 onto the imaginary plane VP7 is defined as a projection line segment PD7. Further, a projection line segment that is obtained by projecting the cross section of the first portion 81a onto the imaginary plane VP8 is defined as a projection line segment PD8. Also in the example which is shown in FIG. 15, the coil wire 55 is formed such that the projection line segment PD7 is longer than the projection line segment PD8.

Therefore, the first portion 81a and the second portion 81b face each other in the direction of arrangement AD4 over a large area, and the third portion 81c and the second portion 81b face each other in the direction of arrangement AD4 over a large area, for example, which increases the capacitance of the coil 24.

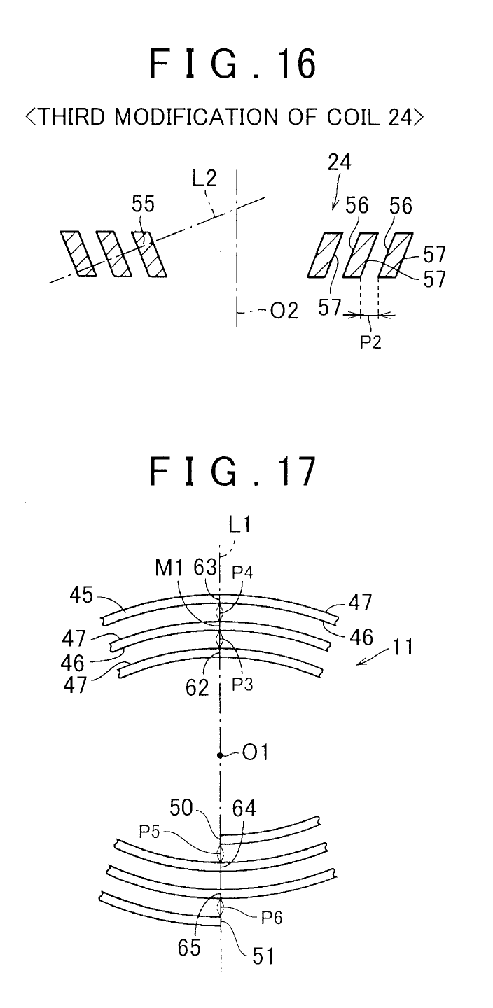

FIG. 16 is a cross-sectional view that shows a third modification of the coil 24. In the example which is shown in FIG. 16, the main surface 56 and the main surface 57 are arranged on an imaginary line (imaginary plane) L2 that intersects the winding center line O2 at an angle that is less than 90 degrees.

The coil 24 is thus formed such that the main surface 56 and the main surface 57 of the coil wire 55 are arranged on an imaginary line (imaginary plane) that extends in a direction that intersects the winding center line O2.

In the thus formed coil 24, a floating capacitance is formed between the main surface 56 and the main surface 57 which face each other with a pitch P2. The areas of the main surface 56 and the main surface 57 are large, and therefore the floating capacitance which is formed between the main surface 56 and the main surface 57 is also large. The pitch P2 of the coil 24 is smaller than the height H2 of the coil 24 (width W2 of the coil wire 55), and therefore a larger capacitance is formed between the main surface 56 and the main surface 57. Thus, an increase in floating capacitance of the coil 24 reduces the specific frequency of the electric circuit which is formed by the floating capacitance of the coil 24 and the inductance of the coil 24.

The specific frequency of the coil 24 and the specific frequency of the coil 11 coincide with each other. The frequency of electric power that is supplied to the coil 24 is set to the specific frequency of the coil 24, 11 or a frequency that is close thereto.

When the frequency of electric power that is supplied to the coil 24 is thus set to be low, the frequency of electric power that is supplied from the coil 23 to the coil 24 in FIG. 6 is also set to be low. When electric power that is supplied by the coil 24 is lowered, the frequency of the magnetic field which is formed around the coil 24 is also lowered. When the frequency of the magnetic field which is formed around the coil 24 and the coil 11 is lowered, the frequency of electric power that is supplied to the coil 11 can also be lowered. The electric power which is supplied to the coil 11 is taken out by the coil 12, and thereafter supplied to the battery 15 through the rectifier 13 and the converter 14 which are shown in FIG. 1.

With the thus configured electric power transfer system according to the embodiment, electric power can be transferred at a low frequency. Further, the frequency of electric power that flows through the AC power source 21, the high-frequency electric power driver 22, the rectifier 13, and the converter 14 is lowered, which makes it possible to simplify the configuration of such devices. Further, along with a reduction in frequency of electric power, the flow of control performed by the control section 26 and the vehicle ECU 18 can be simplified.

Further, as is clear from FIG. 6, the height H1 of the coil 11 corresponds to the width W1 which is shown in FIG. 7. Therefore, the height of the coil 11 is made compact.

Similarly, the height H2 of the coil 24 corresponds to the width W2 of the coil 55 which is shown in FIG. 12. Thus, the coil 24 can be made compact.

FIG. 17, is a plan view that shows a part of the coil 11. In FIG. 17, the main surface 47 and the main surface 46 of the coil 11 are arranged in the direction of extension of the imaginary line L1 which perpendicularly crosses the winding center line O1.

A portion of the coil 11 that is positioned at the center portion of the coil wire 45 in the longitudinal direction is defined as a center portion M1. A portion 62, the center portion M1, and a portion 63 are arranged on the imaginary line L1.

The pitch between the portion 62 and the center portion M1 is defined as a pitch P3. The pitch between the center portion M1 and the portion 63 is defined as a pitch P4.

In addition, the end portion 50, a portion 64, a portion 65, and the end portion 51 are sequentially arranged on the imaginary line L1. The pitch between the end portion 50 and the portion 64 is defined as a pitch P5. The pitch between the portion 65 and the end portion 51 is defined as a pitch P6.

The coil wire 45 is wound such that the pitch P4 and the pitch P3 are larger than the pitch P5 and the pitch P6.

During electric power transfer, an AC current flows through the coil 11. In this event, a larger current flows through the center portion M1 than the current which flows through the end portions 50 and 51.

On the other hand, since the pitches P3 and P4 on both sides of the center portion M1 are larger than the pitches P5 and P6 as described above, occurrence of discharge at the center portion M1 can be suppressed.

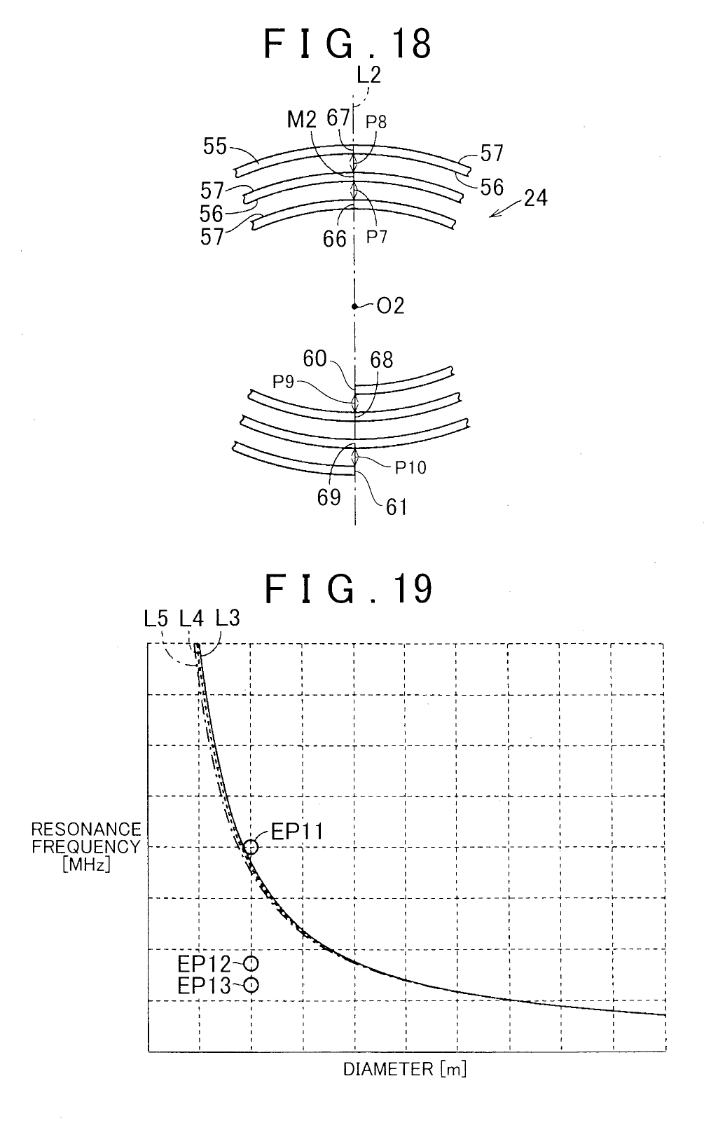

FIG. 18 is a plan view that shows a part of the coil 24. As shown in FIG. 18, the main surface 57 and the main surface 56 of the coil 24 are arranged in the direction of extension of the imaginary line L2 which perpendicularly crosses the winding center line O2.

A portion of the coil 24 that is positioned at the center portion of the coil wire 55 in the longitudinal direction is defined as a center portion M2. A portion 66, the center portion M2, and a portion 67 are arranged on the imaginary line L2.

The pitch between the portion 66 and the center portion M2 is defined as a pitch P7. The pitch between the center portion M2 and the portion 67 is defined as a pitch P8.

In addition, the end portion 60, a portion 68, a portion 69, and the end portion 61 are sequentially arranged on the imaginary line L2. The pitch between the end portion 60 and the portion 68 is defined as a pitch P9. The pitch between the portion 69, and the end portion 61 is defined as a pitch P10.

The coil wire 55 is wound such that the pitch P8 and the pitch P7 are larger than the pitch P9 and the pitch P10.

During electric power transfer, an AC current flows through the coil 24. In this event, a larger current flows through the center portion M2 than the current which flows through the end portions 60 and 61.

On the other hand, since the pitches P7 and P8 on both sides of the center portion M2 are larger than the pitches P9 and P10 as described above, occurrence of discharge at the center portion M2 can be suppressed. The coil 11 and the coil 24 are wound in the same direction. However, the winding directions of the coils 11 and 24 are not necessarily the same as each other.

A coil wire with one of the cross-sectional shapes discussed above is used for each of the coil 11 and the coil 24. Therefore, the coil 11 and the coil 24 have large surface areas compared to those of coils formed from a round wire. When a high-frequency current flows, the current flows through surfaces of a conductor because of the surface effect. Since the coil 11 and the coil 24 have wide surface areas, the electrical resistances of the coil 11 and the coil 24 are suppressed to be low.

FIG. 19 is a graph that shows the resonance frequency (specific frequency) of the coil 11 and the resonance frequency (specific frequency) of a coil according to a comparative example.

Curves L3, L4, and L5 which are shown in FIG. 19 are the simulation results derived using theoretical formulas for copper-wire coils. In the graph, the vertical axis indicates the resonance frequency of each coil, and the horizontal axis indicates the diameter of each coil.

The curve L3 indicates the resonance frequency of a coil that is formed by winding a coil wire with five turns with a pitch of 1 mm. The diameter of the coil wire is 1 mm.

The curve L4 indicates the resonance frequency of a coil that is formed by winding a coil wire with five turns with a pitch of 2 mm. The diameter of the coil wire is 1 mm. The curve L5 indicates the resonance frequency of a coil that is formed by winding a coil wire with five turns with a pitch of 3 mm. The diameter of the coil wire is 1 mm.

The coil loop diameter is defined as “D”. The length of the coil wire is defined as “p”. The wavelength of a current that flows through the coil is defined as “λ”. The Nagaoka coefficient is defined as “K”. The magnetic permeability in the air is defined as “μ”. The number of winding turns of the coil is defined as “N”. The coil loop radius (=D/2) is defined as “a”. The light speed is defined as “Vc”. Then, the theoretical formula for the inductance (L) of the coil is indicated by the following formula (4). The theoretical formula for the capacitance (C) of the coil is indicated by the following formula (5). The theoretical formula for the resonance frequency (fc) of the coil is indicated by the following formula (6).

L=KμπD²N/p (4)

C=πaN/[60Vc{ln(2πN)−1}] (5)

fc=1/[2π(LC)^{1/2})] (6)

Experimental points EP11 to EP13 in the graph indicate actually measured values. Specifically, the experimental point EP11 indicates an actually measured value for a coil that is formed by winding a coil wire with a diameter of 1 mm with five turns. The coil has a coil loop diameter of 0.1 m and a pitch of about 3 mm.

It is seen that the experimental point EP11 is very close to the curve L3, and thus the simulation results derived using the theoretical formulas described above are reliable.

The experimental point EP12 indicates an actually measured value for a coil that is formed by winding the coil wire 45 which is shown in FIG. 7 and which has a width of about 1 cm. The coil which corresponds to the experimental point EP12 is formed by winding the coil wire with 3.8 turns. The coil has a coil loop diameter of 0.1 m and a pitch of about 3 mm. The resonance frequency of the coil which corresponds to the experimental point EP12 is 17.6 MHz.

The experimental point EP13 indicates an actually measured value for a coil that is formed by winding the coil wire 45 which is shown in FIG. 7 and which has a width of about 2 cm. The coil which corresponds to the experimental point EP13 is formed by winding the coil wire with 3.8 turns. The coil has a coil loop diameter of 0.1 m and a pitch of about 3 mm. The resonance frequency of the coil which corresponds to the experimental point EP13 is 13.6 MHz.

It is thus found that the resonance frequency of the electric circuit which is formed by the coil 11 and the coil 24 according to the embodiment can be suppressed to be low.

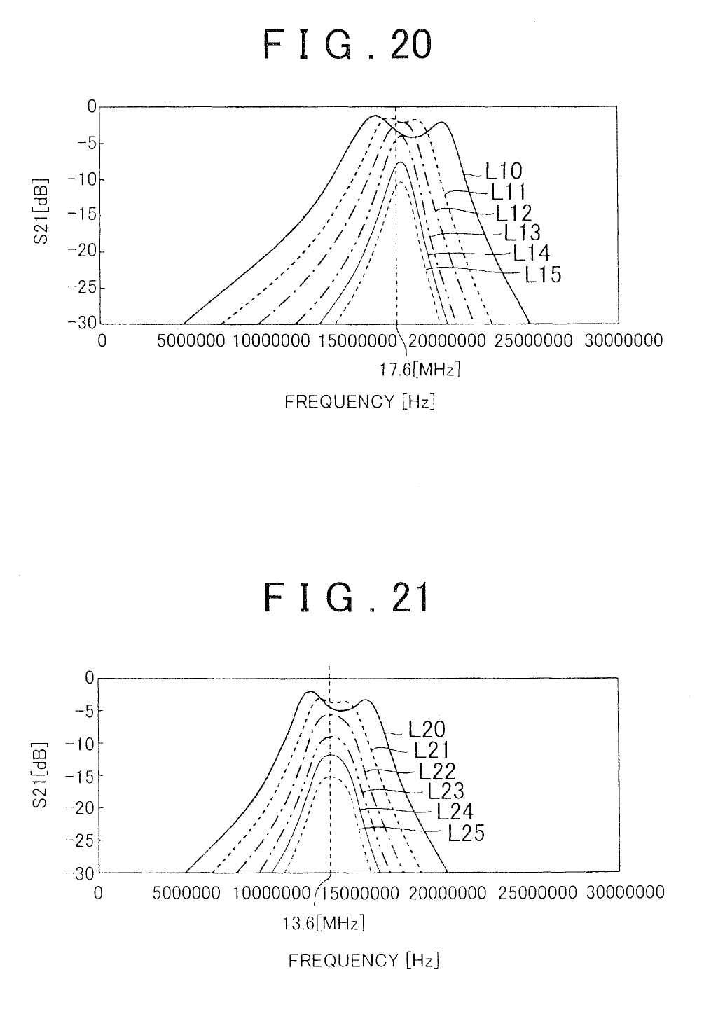

FIGS. 20 and 21 are each a graph that shows the electric power transfer efficiency with the air gap between the coil 11 and the coil 24 varied.

The vertical axis indicates the electric power transfer efficiency (S21 [dB]), and the horizontal axis indicates the frequency of electric power that is supplied to the coil 24.

In FIG. 20, the coil 11 and the coil 24 are formed by winding a coil wire with a width W (height H1 of the coil 11) of 1 cm with 3.8 turns. The pitch of each of the coil 11 and the coil 24 is about 2 mm to 5 mm. An insulating tape that serves as an, insulator is provided between the turns of the coil wire.

In the example which is shown in FIG. 21, the coil 11 and the coil 24 are formed by winding a coil wire with a width W (height H1 of the coil 11) of 2 cm with 3.8 turns. The pitch of each of the coil 11 and the coil 24 is about 2 mm to 5 mm. An insulating tape that serves as an insulator is provided between the turns of the coil wire.

In FIG. 20, the distance between the coil 11 and the coil 24 is defined as “X”. A curve L10 indicates the electric power, transfer efficiency which is achieved at a distance X of 2 cm and with allowing the frequency of electric power that is supplied to the coil 24 to be varied.

Similarly, curves L11, L12, L13, L14, and L115 indicate the electric power transfer efficiencies at distances X of 4 cm, 6 cm, 8 cm, 10 cm, and 12 cm, respectively.

In FIG. 21, curves L20, L21, L22, L23, L24, and L25 indicate the electric power transfer efficiencies at distances X of 2 cm, 4 cm, 6 cm, 8 cm, 10 cm, and 12 cm, respectively.

In the example which is shown in FIG. 20, the center frequency is 17.6 MHz. As is clear from FIG. 20, with the distance X varied, the electric power transfer efficiency is high at the center frequency or frequencies around the center frequency.

Thus, a high electric power transfer efficiency can be secured by appropriately adjusting the frequency of electric power that is supplied to the coil 24 to the center frequency or frequencies around the center frequency in accordance with variations in distance X.

On the other hand, in the case where the coil 11 and the coil 24 are formed from a copper wire with a diameter of 1 mm, for example, the center frequency is about 40 MHz to 70 MHz. Such coils also have a pitch of about 2 mm to 5 mm and a number of winding turns of about 3.8.

It is thus found that the electric power transfer system which includes the coil 11 and the coil 24 according to the embodiment can achieve a reduction in frequency of electric power.

In the example which is shown in FIG. 21, the center frequency is 13.6 MHz. As is clear from FIG. 21, in addition, even if the distance X is varied, the electric power transfer efficiency is high at the center frequency or frequencies around the center frequency.

It is therefore found that the electric power transfer system which includes the coil 11 and the coil 24 of FIG. 21 can also achieve a reduction in frequency of electric power. Thus, with the electric power transfer system according to the embodiment, it is possible to achieve a reduction in frequency of electric power that flows through an electric power transmission device, an electric power reception device, peripheral devices that are connected to the electric power transmission device, and peripheral devices that are connected to the electric power reception device.

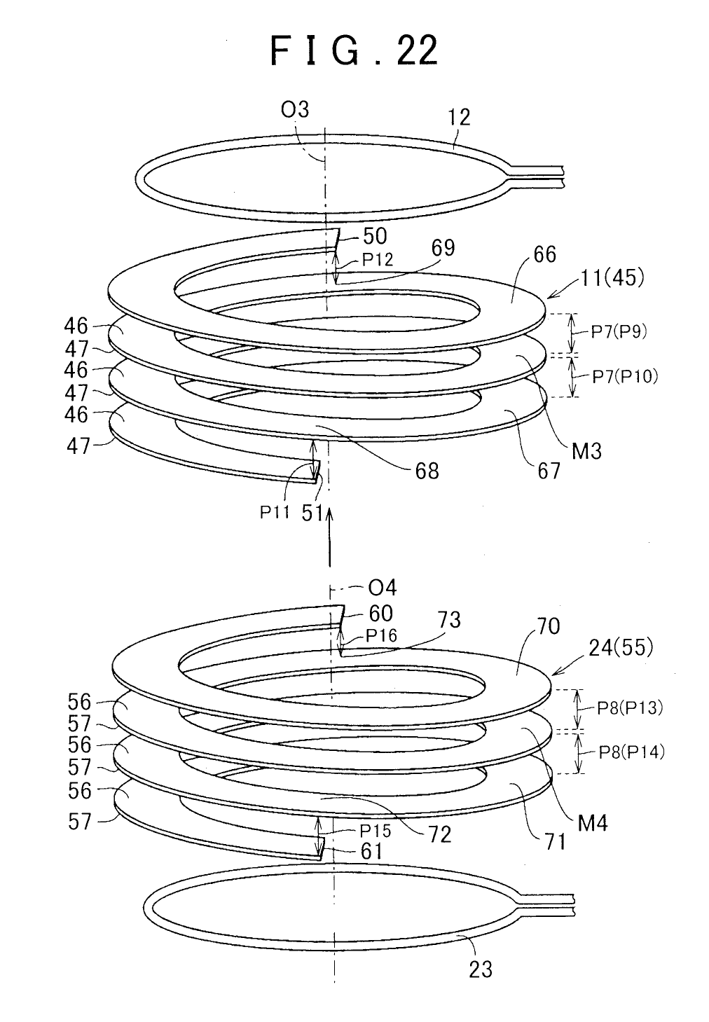

Next, an electric power transfer system, an electric power transmission device, and an electric power reception device according to a second embodiment will be described with reference to FIGS. 22 to 24. Components that are shown in FIGS. 22 to 24 and that are the same as or, equivalent to the components which are shown in FIGS. 1 to 21 are denoted by the same reference symbols, and description thereof may be omitted.

FIG. 22 is a perspective view that schematically shows an essential portion of the electric power reception device and the electric power transmission device according to the second embodiment. Also in the example which is shown in FIG. 22, the coil 11 is formed by winding the coil wire 45, and the coil 24 is also formed by winding the coil wire 55.

The coil 11 includes the end portion 50 and the end portion 51. The coil wire 11 is formed so as to surround a winding center line O3 and so as to be displaced in the direction of extension of the winding center line O3 as the coil wire 45 extends from the end portion 50 toward the end portion 51.

That is, in the example which is shown in FIG. 22, the coil 22 is formed spirally so as to be concentric about the winding center line O3. Typically, the coil 11 is formed in a circular shape that is centered on the winding center line O3 as the coil 11 is seen on the winding center line O3. However, the shape of the coil 11 is not limited thereto.

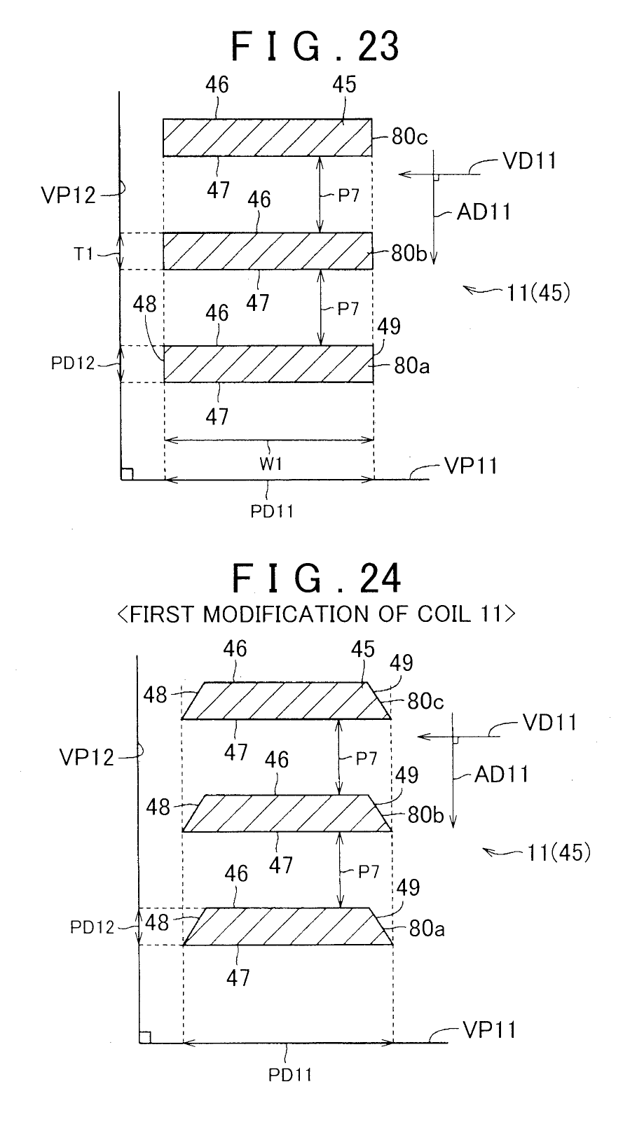

The main surface 46 and the main surface 47 of the coil wire 45 are disposed with an interval between each other in the direction of extension of the winding center line O3. Specifically, the main surface 46 and the main surface 47 are disposed so as to face each other with a pitch P7 between each other. FIG. 23 is a cross-sectional view that shows a part of the coil 11. In FIG. 23, both the area of the main surface 46 and the area of the main surface 47 are larger than both the area of the side surface 48 and the area of the side surface 49. The third portion 80c, the second portion 80b, and the first portion 80a are arranged in a direction of arrangement AD11. In the example which is shown in FIG. 23, the direction of arrangement AD11 is parallel to the winding center line O3. A direction that is perpendicular to the direction of arrangement AD11 is defined as a vertical direction VD11.

An imaginary plane that is perpendicular to the direction of arrangement AD11 is defined as an imaginary plane VP11. An imaginary plane that is perpendicular to the vertical direction VD11 is defined as an imaginary plane VP12. A projection line segment that is obtained by projecting the cross section of the first portion 80a from the direction of arrangement AD11 onto the imaginary plane VP11 is defined as a projection line segment PD11. A projection line segment that is obtained by projecting the cross section of the first portion 80a from the vertical direction VD11 onto the imaginary plane VP12 is defined as a projection line segment PD12. As is clear from FIG. 23, the projection line segment PD11 is longer than the projection line segment PD12. Therefore, also in the second embodiment, a large capacitance can be formed in the coil 11.

In the example which is shown in FIG. 23, both the direction of the pitch P7 and the direction of arrangement AD11 match the direction of extension of the winding center line O3 which is shown in FIG. 22. Therefore, the thickness direction of the coil wire 45 matches the direction of arrangement AD11, and the main surface 46 and the main surface 47 with a large area faced each other. Therefore, the coil 11 has a large floating capacitance.

The pitch P7 is smaller than the width W1 of the coil wire 45. Therefore, the height of the coil 11 which is shown in FIG. 22 is suppressed to be low. Further, the floating capacitance of the coil 11 can be increased by reducing the pitch P7. The pitch P7 is approximately equal to or more than 2 mm and equal to or less than 5 mm, for example.

The thus formed coil 11 has an inductance of the coil 11 and a floating capacitance of the coil 11, resulting in forming an electric circuit.

In FIG. 22, a portion of the coil 11 that is positioned at the center portion of the coil wire 45 in the longitudinal direction is defined as a center portion M3.

Portions of the coil 11 that are adjacent to the center portion M3 in the direction of extension of the winding center line O3 are defined as a portion 66 and a portion 67. A portion of the coil 11 that is adjacent to the end portion 51 in the direction of extension of the winding center line O3 is defined as a portion 68. A portion of the coil 11 that is adjacent to the end portion 50 in the direction of extension of the winding center line O3 is defined as a portion 69.

The pitch between the center portion M3 and the portion 66 is defined as a pitch P9. The pitch between the center portion M3 and the portion 67 is defined as a pitch P10. The pitch between the end portion 51 and the portion 68 is defined as a pitch P11. The pitch between the end portion 50 and the portion 69 is defined as a pitch P12. Both the pitch P9 and the pitch 10 are larger than both the pitch P11 and the pitch P12.

A large current flows through the center portion M3 of the coil 11 during electric power transfer. On the other hand, occurrence of discharge between the center portion M3 and the portion 66 or between the center portion M3 and the portion 67 can be suppressed by increasing the pitch P9 and the pitch P10 as described above.

FIG. 24 is a cross-sectional view that shows a first modification of the coil 11 which is shown in FIG. 23. In the example which is shown in FIG. 24, the cross section of the coil wire 45 has a trapezoidal shape. Also in the example which is shown in FIG. 24, the third portion 80c, the second portion 80b, and the first portion 80a are arranged in the direction of arrangement AD11, and the projection line segment PD11 is longer than the projection line segment PD12. Therefore, also in the example which is shown in FIG. 24, a large capacitance is formed in the coil 11.

Specifically, for the third portion 80c and the second portion 80b, the main surface 47 of the second portion 80b and the main surface 46, the side surface 48, and the side surface 49 of the third portion 80c face each other, which forms a large capacitance between the third portion 80c and the second portion 80b. Similarly, a large capacitance is also formed between the first portion 80a and the second portion 80b.

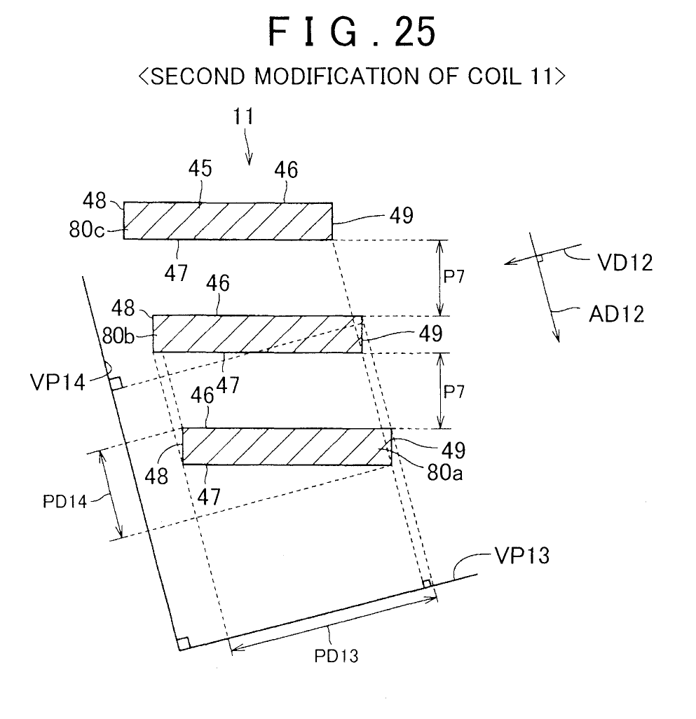

FIG. 25 is a cross-sectional view that shows a second modification of the coil 11 which is shown in FIG. 23. In the example which is shown in FIG. 25, the coil 11 is formed so as to be displaced along the winding center line O3 and so as to become larger in winding diameter as the coil wire 45 extends from the lower end portion toward the other, upper end portion.

Therefore, in the example which is shown in FIG. 25, the direction of arrangement AD12 and the direction of the pitch P7 do not coincide with each other, and the direction of arrangement AD12 intersects the direction of the pitch P7 and the winding center line O3. On the other hand, also in the example which is shown in FIG. 25, the length of a projection line segment PD13 is larger than the length of a projection line segment PD14, which forms a large capacitance between the third portion 80c and the second portion 80b and between the second portion 80b and the first portion 80a.

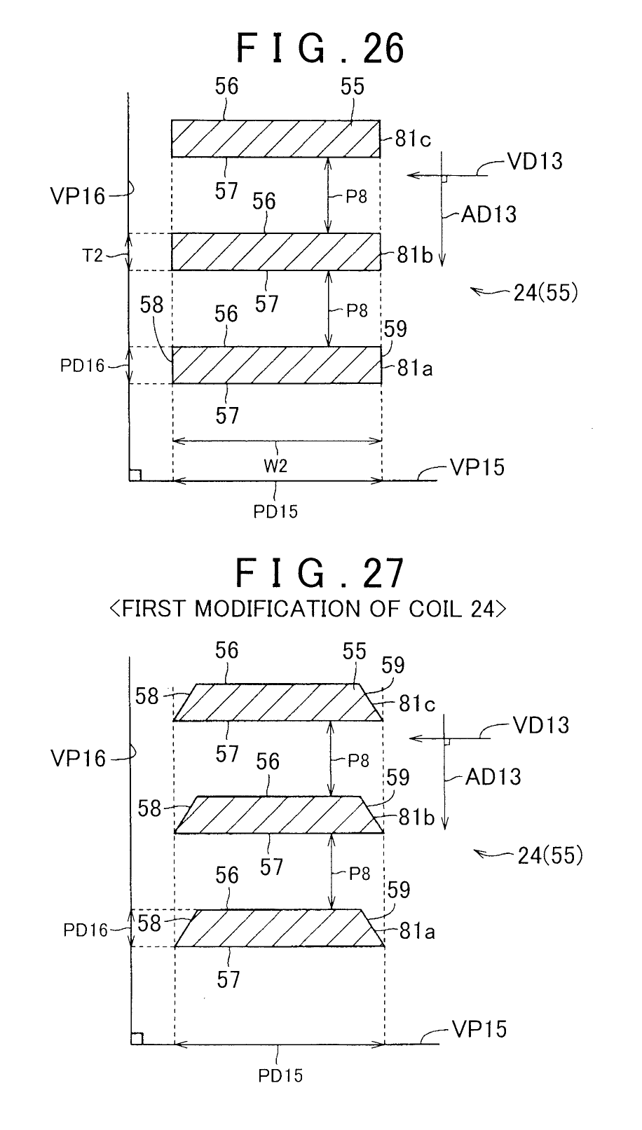

The coil 24 is formed spirally about a winding center line O4. The main surface 56 and the main surface 57 of the coil wire 55 are disposed with an interval between each other in the direction of extension of the winding center line O4. Specifically, the main surface 56 and the main surface 57 are disposed so as to face each other with a pitch P8 between each other. FIG. 26 is a cross-sectional view that shows a part of the coil 24. In FIG. 26, both the area of the main surface 56 and the area of the main surface 57 are larger than both the area of the side surface 58 and the area of the side surface 59. The third portion 81c, the second portion 81b, and the first portion 81a are arranged in a direction of arrangement AD13. In the example which is shown in FIG. 26, the direction of arrangement AD13 is parallel to the winding center line O4. A direction that is perpendicular to the direction of arrangement AD13 is defined as a vertical direction VD13.

An imaginary plane that is perpendicular to the direction of arrangement AD13 is defined as an imaginary plane VP15. An imaginary plane that is perpendicular to the vertical direction VD13 is defined as an imaginary plane VP16. A projection line segment that is obtained by projecting the cross section of the first portion 81a from the direction of arrangement AD13 onto the imaginary plane VP15 is defined as a projection line segment PD15. A projection line segment that is obtained by projecting the cross section of the first portion 81a from the vertical direction VD13 onto the imaginary plane VP16 is defined as a projection line segment PD16. As is clear from FIG. 26, the projection line segment PD15 is longer than the projection line segment PD16. Therefore, also in the second embodiment, a large capacitance can be formed in the coil 24.

In the example which is shown in FIG. 26, both the direction of the pitch P8 and the direction of arrangement AD13 match the direction of extension of the winding center line O4 which is shown in FIG. 22. Therefore, the thickness direction of the coil wire 55 matches the direction of arrangement AD13, and the main surface 56 and the main surface 57 with a large area face each other. Therefore, the coil 24 has a large floating capacitance. The winding direction of the coil wire 55 may be opposite to the winding direction of the coil wire 55 which is shown in FIG. 22.

The pitch P8 is smaller than the width W2 of the coil wire 55. Therefore, the height of the coil 24 which is shown in FIG. 22 is suppressed to be low. Further, the floating capacitance of the coil 24 can be increased by reducing the pitch P8. The pitch P8 is approximately equal to or more than 2 mm and equal to or less than 5 mm, for example.

The thus formed coil 24 has an inductance of the coil 24 and a floating capacitance of the coil 24, which form an electric circuit. In FIG. 22, a portion of the coil 24 that is positioned at the center portion of the coil wire 55 in the longitudinal direction is defined as a center portion M4.

Portions of the coil 24 that are adjacent to the center portion M4 in the direction of extension of the winding center line O4 are defined as a portion 70 and a portion 71. A portion of the coil 24 that is adjacent to the end portion 61 in the direction of extension of the winding center line O4 is defined as a portion 72. A portion of the coil 24 that is adjacent to the end portion 60 in the direction of extension of the winding center line O4 is defined as a portion 73.

The pitch between the center portion M4 and the portion 70 is defined as a pitch P13. The pitch between the center portion M4 and the portion 71 is defined as a pitch P14. The pitch between the end portion 51 and the portion 72 is defined as a pitch P15. The pitch between the end portion 50 and the portion 73 is defined as a pitch P16.

Both the pitch P13 and the pitch 14 are larger than both the pitch P15 and the pitch P16.

A large current flows through the center portion M4 of the coil 24 during electric power transfer. On the other hand, occurrence of discharge between the center portion M4 and the portion 70 or between the center portion M4 and the portion 71 can be suppressed by increasing the pitch P13 and the pitch P14 as described above.

FIG. 27 is a cross-sectional view that shows a first modification of the coil 24 which is shown in FIG. 26. In the example which is shown in FIG. 27, the cross section of the coil wire 55 has a trapezoidal shape. Also in the example which is shown in FIG. 27, the third portion 81c, the second portion 81b, and the first portion 81a are arranged in the direction of arrangement AD13, and the projection line segment PD15 is longer than the projection line segment PD16. Therefore, also in the example which is shown in FIG. 27, a large capacitance is formed in the coil 24.

Specifically, for the third portion 81c and the second portion 81b, the main surface 57 of the second portion 81b and the main surface 56, the side surface 58, and the side surface 59 of the third portion 81c face each other, which forms a large capacitance between the third portion 81c and the second portion 81b. Similarly, a large capacitance is also formed between the first portion 81a and the second portion 81b.

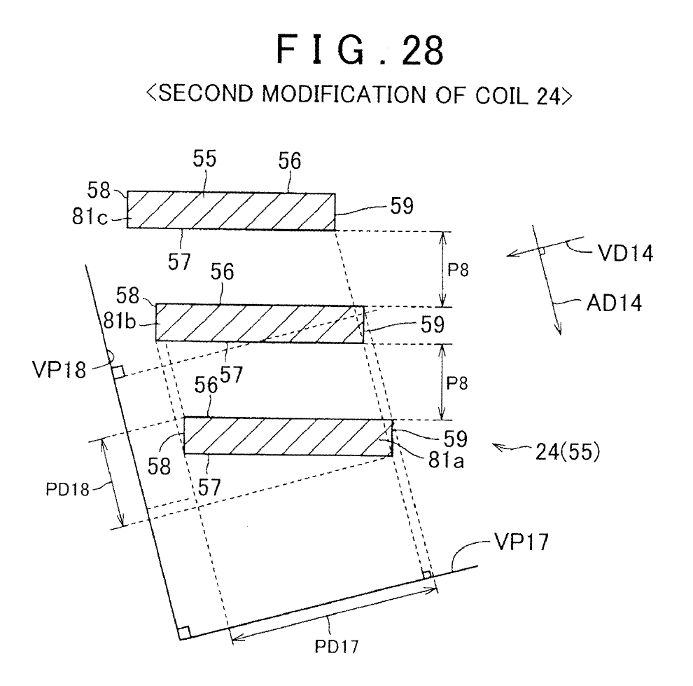

FIG. 28 is a cross-sectional view that shows a second modification of the coil 24 which is shown in FIG. 26. In the example which is shown in FIG. 28, the coil 24 is formed so as to be displaced along the winding center line O4 and so as to become larger in winding diameter as the coil wire 55 extends from the lower end portion toward the other, upper end portion.

Therefore, in the example which is shown in FIG. 28, the direction of arrangement AD14 and the direction of the pitch P8 do not coincide with each other, and the direction of arrangement AD14 intersects the direction of the pitch P8 and the winding center line O4. On the other hand, also in the example which is shown in FIG. 28, the length of a projection line segment PD17 is larger than the length of a projection line segment PD18, which forms a large capacitance between the third portion 81c and the second portion 81b and between the second portion 81b and the first portion 81a.

Also in the embodiment, the specific frequency of the electric circuit which is formed by the coil 11 and the specific frequency of the electric circuit which is formed by the coil 24 coincide with each other. Further, the coupling coefficient between the coil 11 and the coil 24 is equal to or less than 0.1.

Although embodiments of the present invention have been described above, it should be considered that the embodiments disclosed herein are illustrative in all respects and are not limiting. The scope of the present invention is defined by the claims, and intended to include all equivalents and modifications that fall within the scope of the claims. The present invention can be applied to an electric power reception device, an electric power transmission device, and an electric power transfer system.

What is claimed is:

1. An electric power reception device comprising:
an electric power reception section configured to receive electric power in a non-contact manner from an electric power transmission section that is provided externally and to include a first coil that is formed by winding a first coil wire with a pitch,
the first coil including a first portion and a second portion that is adjacent to the first portion with the pitch, and
the first portion and the second portion being arranged in a direction of arrangement, wherein,
a cross section of the first coil wire that is perpendicular to a direction of extension of the first coil wire is configured such that a length of a first projection line that is obtained by projecting the cross section from the direction of arrangement onto a first imaginary plane that is perpendicular to the direction of arrangement is larger than a length of a second projection line that is obtained by projecting the cross section from a direction that is perpendicular to the direction of arrangement onto a second imaginary plane that is perpendicular to the first imaginary plane,
the pitch at a center portion of the first coil that is positioned at a center portion of the first coil wire in a longitudinal direction is larger than the pitch at an end portion of the first coil that is positioned at a center portion of the first coil wire in a longitudinal direction.

2. The electric power reception device according to claim 1, wherein the first coil wire includes a first main surface and a second main surface, and a first side surface and a second side surface that are provided to connect between the first main surface and the second main surface, and
both an area of the first main surface and an area of the second main surface are larger than both an area of the first side surface and an area of the second side surface.

3. The electric power reception device according to claim 1, wherein
the pitch of the first coil is smaller than a width of the first coil wire.

4. The electric power reception device according to claim 1, wherein
the first coil includes a first end portion and a second end portion, and
the first coil is formed by bending the first coil wire so as to surround a winding center line and so as to be displaced in a direction of extension of the winding center line as the first coil wire extends from the first end portion toward the second end portion, and
the first portion and the second portion are arranged in the direction of extension of the winding center line.

5. (canceled)

6. The electric power reception device according to claim 1, wherein
the first coil includes a first end portion and a second end portion,
the first coil wire is bent so as to surround a winding center line and so as to extend away from the winding center line as the first coil wire extends from the first end portion toward the second end portion, and
the first coil is formed by winding the first coil wire such that the winding center line and the direction of arrangement of the first portion and the second portion intersect each other.

7. (canceled)

8. The electric power reception device according to claim 1, wherein
the cross section of the first coil wire that is perpendicular to the direction of extension of the first coil wire has a rectangular shape.

9. The electric power reception device according to claim 1, wherein
a difference between a specific frequency of the electric power transmission section and a specific frequency of the electric power reception section is equal to or less than 10% of the specific frequency of the electric power reception section.

10. The electric power reception device according to claim 1, wherein
the electric power reception section receives electric power from the electric power transmission section through at least one of a magnetic field that is formed between the electric power reception section and the electric power transmission section and that vibrates at a particular frequency, and an electric field that is formed between the electric power reception section and the electric power transmission section and that vibrates at a particular frequency.

11. The electric power reception device according to claim 1, wherein
a coupling coefficient between the electric power reception section and the electric power transmission section is equal to or less than 0.1.

12. An electric power transmission device comprising:
an electric power transmission section configured to transmit electric power in a non-contact manner to an electric power reception section that is provided externally and that includes a second coil that is formed by winding a second coil wire with a pitch,
the second coil including a third portion and a fourth portion that is adjacent to the third portion with the pitch, and
the third portion and the fourth portion being arranged in a direction of arrangement, wherein
a cross section of the second coil wire that is perpendicular to a direction of extension of the second coil wire is configured such that a length of a third projection line that is obtained by projecting the cross section from the direction of arrangement onto a third imaginary plane that is perpendicular to the direction of arrangement is larger than a length of a fourth projection line that is obtained by projecting the cross section from a direction that is perpendicular to the direction of arrangement onto a fourth imaginary plane that is perpendicular to the third imaginary plane,
the pitch at a center portion of the second coil that is positioned at a center portion of the second coil wire in a longitudinal direction is larger than the pitch at an end portion of the second coil that is positioned at a center portion of the second coil wire in a longitudinal direction.

13. The electric power transmission device according to claim 12, wherein
the second coil wire includes a third main surface and a fourth main surface, and a third side surface and a fourth side surface that are provided to connect between the third main surface and the fourth main surface, and
both an area of the third main surface and an area of the fourth main surface are larger than both an area of the third side surface and an area of the fourth side surface.

14. The electric power transmission device according to claim 12, wherein
the pitch of the second coil is smaller than a width of the second coil wire.

15. The electric power transmission device according to claim 12, wherein
the second coil includes a third end portion and a fourth end portion,
the second coil is formed by bending the second coil wire so as to surround a winding center line and so as to be displaced in a direction of extension of the winding center line as the second coil wire extends from the third end portion toward the fourth end portion, and
the third portion and the fourth portion are arranged in the direction of extension of the winding center line.

16. (canceled)

17. The electric power transmission device according to claim 12, wherein
the second coil includes a third end portion and a fourth end portion,
the second coil wire is bent so as to surround a winding center line and so as to extend away from the winding center line as the second coil wire extends from the third end portion toward the fourth end portion, and
the second coil is formed by winding the second coil wire such that the winding center line and the direction of arrangement of the third portion and the fourth portion intersect each other.

18. (canceled)

19. The electric power transmission device according to claim 12, wherein
the cross section of the second coil wire that is perpendicular to the direction of extension of the second coil wire has a rectangular shape.

20. The electric power transmission device according to claim 12, wherein
a difference between a specific frequency of the electric power transmission section and a specific frequency of the electric power reception section is equal to or less than 10% of the specific frequency of the electric power reception section.

21. The electric power transmission device according to claim 12, wherein
the electric power transmission section transmits electric power to the electric power reception section through at least one of a magnetic field that is formed between the electric power reception section and the electric power transmission section and that vibrates at a particular frequency, and an electric field that is formed between the electric power reception section and the electric power transmission section and that vibrates at a particular frequency.

22. The electric power transmission device according claim 12, wherein
a coupling coefficient between the electric power reception section and the electric power transmission section is equal to or less than 0.1.

23. An electric power transfer system comprising:
an electric power reception device that includes an electric power reception section that includes a first coil that is formed by winding a first coil wire with a pitch,
the first coil including a first portion and a second portion that is adjacent to the first portion with the pitch, and
the first portion and the second portion being arranged in a direction of arrangement; and
an electric power transmission device that includes an electric power transmission section that transmits electric power in a non-contact manner to the electric power reception section, wherein
a cross section of the first coil wire that is perpendicular to a direction of extension of the first coil wire is configured such that a length of a first projection line that is obtained by projecting the cross section from the direction of arrangement onto a first imaginary plane that is perpendicular to the direction of arrangement is larger than a length of a second projection line that is obtained by projecting the cross section from a direction that is perpendicular to the direction of arrangement onto a second imaginary plane that is perpendicular to the first imaginary plane;
the pitch at a center portion of the first coil that is positioned at a center portion of the first coil wire in a longitudinal direction is larger than the pitch at an end portion of the first coil that is positioned at a center portion of the first coil wire in a longitudinal direction.

24. An electric power transfer system comprising:
an electric power reception device that includes an electric power reception section; and
an electric power transmission device that includes an electric power transmission section that includes a second coil that is formed by winding a second coil wire with a pitch and that transmits electric power in a non-contact manner to the electric power reception section,
the second coil including a third portion and a fourth portion that is adjacent to the third portion with the pitch, and
the third portion and the fourth portion being arranged in a direction of arrangement, wherein
a cross section of the second coil wire that is perpendicular to a direction of extension of the second coil wire is configured such that a length of a third projection line that is obtained by projecting the cross section from the direction of arrangement onto a third imaginary plane that is perpendicular to the direction of arrangement is larger than a length of a fourth projection line that is obtained by projecting the cross section from a direction that is perpendicular to the direction of arrangement onto a fourth imaginary plane that is perpendicular to the third imaginary plane,
the pitch at a center portion of the second coil that is positioned at a center portion of the second coil wire in a longitudinal direction is larger than the pitch at an end portion of the second coil that is positioned at a center portion of the second coil wire in a longitudinal direction.
